(19) United States
(12) Patent Application Publication
(10) Pub. No.: US 2015/0009359 A1
(43) Pub. Date: Jan. 8, 2015

(54) METHOD AND APPARATUS FOR COLLABORATIVE DIGITAL IMAGING

(71) Applicant: Groopic Inc., Atherton, CA (US)

(72) Inventors: Aamer ZAHEER, Lahore (PK); Ali REHAN, Lahore Cantt (PK); Murtaza TAJ, Karachi (PK); Abdul REHMAN, Lahore Cantt (PK)

(73) Assignee: GROOPIC INC., Atherton, CA (US)

(21) Appl. No.: 14/219,967

(22) Filed: Mar. 19, 2014

Related U.S. Application Data
(60) Provisional application No. 61/803,122, filed on Mar. 19, 2013.

(30) Foreign Application Priority Data
Jan. 13, 2014 (PK) 20/2014

(51) Int. Cl. H04N 1/60; G06K 9/00; H04N 5/232; H04N 5/265; G06T 7/00

(52) U.S. Cl. CPC H04N 1/6077; H04N 5/265; G06T 7/0028; H04N 5/23219; H04N 5/23216; G06K 9/00221
USPC 348/223.1; 348/239

(57) ABSTRACT

Methods and apparatus for collaborative digital imaging are disclosed. A method for digital imaging may include receiving a first image and a second image; aligning the first image with the second image; determining a first point of interest within the first image; determining a second point of interest within the second image; identifying a border for the aligned images; and creating a composite image from the aligned first and second images and the border. The composite image may include a first region of the first aligned image that includes the first point of interest and a second region of the second image that includes the second point of interest.

### CROSS REFERENCE TO RELATED APPLICATIONS

This application claims priority to U.S. Provisional Patent Application No. 61/803,122, filed Mar. 19, 2013, and to Pakistan Patent Application No. 20/2014, filed Jan. 13, 2014, both of which are incorporated by reference in their entirety as though fully disclosed herein.

### TECHNICAL FIELD

The invention relates generally to the field of image signal processing. More specifically, the present invention relates to collaborative photography.

### BACKGROUND

In general, cameras are designed to take a picture of a scene including people and objects that are present in the field of view of the camera. Any object not present in the field of view of the camera is not captured in the image. To introduce additional objects in the picture, one currently available option is to take pictures at several locations and then stitch them together into one large final image. This is commonly referred to as a panoramic view. Another currently available option is to paste a piece of one image into another image or in the same image at another location. It has also been demonstrated that an object not in front of the camera can be captured by using an additional camera.

In all the aforementioned currently available options, the images of different locations are captured through a camera by the same photographer or different photographers. However, existing options do not allow collaboration between multiple photographers to take multiple images of the same scene by replacing scene objects such that the final image either contains additional scene objects or fewer objects as compared to the actual scene. More specifically, existing options do not provide any mechanism for including the photographer in the scene. Similarly, currently available solutions do not provide any mechanism through which the images taken at different physical locations by different people at different times can be merged into a single photograph. In other words, the currently available options fail to fully exploit the range of opportunities for collaboration between multiple photographers to produce images by combining multiple photographs, whether those photographs are taken at the same or different locations during the same or different sessions.

### BRIEF SUMMARY OF THE INVENTION

The above-mentioned shortcomings of existing image processing methods for adding additional objects in the scene are overcome by the present invention, which relates to a novel system and method of collaborative photography for multiple photographers. An aspect of the invention provides a method for multiple photographers to collaborate with each other in taking a single final image of a scene, which facilitates adding additional objects in the scene. The method facilitates including all the photographers in the final photographs generated through their collaborative input to the system. The method facilitates taking multiple pictures of the scene or different scenes by multiple photographers such that the final image contains all the photographers.

An aspect of the present invention provides a method to combine images taken by multiple photographers with very little input from the user—as few as a single tap on the touch screen for each photographer. For collaborative photography between two photographers, the method includes both the photographers in the picture with only two taps on the touch screen or two clicks using a pointing device. This method will be referred to as “tap-with-snap,” indicating that the user selects the photographer while snapping the picture.

According to another aspect of the present invention, there is provided a method to combine images taken by multiple photographers through smart face detection and selection that assists in automatically selecting regions containing faces that may not be present in one or more images. This enables automatic creation of a final image or sequence of images containing people common in multiple images as well as the photographers. This method will be referred to as “auto-group picture.”

According to another aspect of the present invention, there is provided a method to combine images taken by multiple photographers through smart person detection and selection that assists in automatically selecting regions containing people that may not be present in one or more images. This enables automatic creation of a final image or sequence of images containing people common in multiple images as well as the photographers. This method will be referred to as an aspect of “auto-group picture.”

According to another aspect of the present invention, there is provided a method to combine images taken by multiple photographers through smart face and person detection and selection that assists in automatically selecting regions containing faces and people that may not be present in one or more images. This enables automatic creation of a final image or sequence of images containing people common in multiple images as well as the photographers. This method will be referred to as an aspect of “auto-group picture.”

An aspect of the method allows taking multiple pictures of the scene by replacing objects in the scene such that the final image either contains the same object multiple times, referred to as multiplicity, or one or more objects can be entirely removed from the scene, referred to as invisibility.

According to another aspect of the present invention, there is provided a method of generating and transmitting digital media over a network such that it can be shared on social media with just a single tap on the touch screen or through a click using a pointing device.

According to a further aspect of the present invention, there is provided an apparatus for selecting the relevant areas in the already acquired images with just a tap on the touch screen or through a click using a pointing device, referred to as “tap-after-snap.”

According to a further aspect of the present invention, there is provided a method and system for collaboration between the photographers that allows handover of the imaging device between the photographers while preserving the view of the scene, preserving the settings of the camera device and controlling the amount of light entering the imaging device, preserving the high frequency details of the scene to allow the next photographer in aligning the image with the images taken by the previous photographer.

According to another aspect of the present invention there is provided a stitching apparatus including: a unit to compute the matching pixels in the set of images, a unit to compute transformation differences between the set of images, and a unit to combine multiple images such that the pixel difference on the overlapping region is minimal which is in part ensured by finding the saddle point of the projection histogram in the edge domain.

According to another aspect of the present invention there is provided a method for automatically transforming, segmenting, and blending multiple images to form one or multiple composite images.

According to a further aspect of the present invention, there is provided an auto-rewind feature through a smart face selection algorithm that automatically selects the best face of people in the scene, from a consecutive set of images, and replaces it in the other images, including but not limited to images contributed by photographers and composite images generated by the use of the present invention.

According to an additional aspect of the present invention, collaborative photographers existing at different places can collaborate to create a final image and/or sequence of images containing scenes and/or scene objects from both the places as well as the collaborative photographers. This additional aspect of the present invention can be referred to as “Space Invariant Collaborative Photography.”

According to an additional aspect of the present invention, collaborative photographers existing at the same physical place at different times and/or dates can collaborate to create a final image and/or sequence of images containing scenes and/or scene objects from both times and/or dates as well as the collaborative photographers. This additional aspect of the present invention can be referred to as “Time Invariant Collaborative Photography.” The user, when initiating a photography session, is presented with the photographs of people in his or her social network taken at the same scene in the past, thus allowing the user to obtain a collaborative photograph by utilizing the past historical data.

According to an additional aspect of the present invention, collaborative photographers existing at different physical places at different times and/or dates can collaborate to create a final image and/or sequence of images containing scenes and/or scene objects from all places and all times and/or dates as well as the collaborative photographers. This additional aspect of the present invention can be referred to as “Space and Time Invariant Collaborative Photography.”

According to another additional aspect of the present invention, in particular according to an additional aspect of the “Space and Time Invariant Collaborative Photography” aspect, there is provided a method that allows the photographers to include other individuals and objects in the final image and/or sequence of images that were photographed at the same or different locations and/or scenes or that were created synthetically using computer generated graphics techniques, tools and/or algorithms.

According to another aspect of the present invention there is a scrambling procedure that scrambles an image using a unique ID.

Additional aspects and/or advantages of the invention will be set forth in part in the description which follows and, in part, will be obvious from the description, or may be learned by practice of the invention.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 presents a system flow diagram of the collaborative photography system.

FIG. 2 illustrates a block diagram of the collaborative photography system.

FIGS. 3a and 3b present screenshots of a main screen of the collaborative photography system.

FIGS. 4a, 4b, and 4c show screenshots of a Gallery Summary interface.

FIGS. 5a and 5b present screenshots of the Digital Content Display interface.

FIGS. 6a and 6b show screenshots of the Digital Content editing and enhancement interface through which various signal processing filters can be applied to the content.

FIGS. 7a and 7b illustrate the settings adjustment interface.

FIGS. 8a-8g illustrate a screenshot of the collaborative photography tutorial.

FIG. 9 shows a screenshot of an interface to share digital content.

FIGS. 10a and 10b illustrate an interface for taking a collaborative photograph via live feed from the camera.

FIGS. 11a-11e illustrate an interface for taking consecutive collaborative photographs showing an overlay of a previous photograph to assist in alignment among images.

FIG. 12 illustrates an interface for user input regarding the captured collaborative photograph. This interface will repeat for each consecutive image.

FIG. 13 presents the final image with detected faces and also illustrates an interface to add metadata.

FIGS. 14a and 14b show an interface through which the obtained final image can be shared on social media.

FIGS. 15a-15c illustrate the flow diagram of the collaborative photography apparatus and system.

FIG. 16 shows an automatically-generated collage through the use of the collaborative photography apparatus and system.

FIGS. 17a and 17b illustrate an interface for manual correction of a final composite image.

### DETAILED DESCRIPTION AND BEST MODE OF IMPLEMENTATION

In the following description, numerous specific details are set forth regarding the systems and methods of the disclosed subject matter and the environment in which such systems and methods may operate, in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the embodiments described below are only examples, and that it is contemplated that there are other systems and methods that are within the scope of the disclosed subject matter.

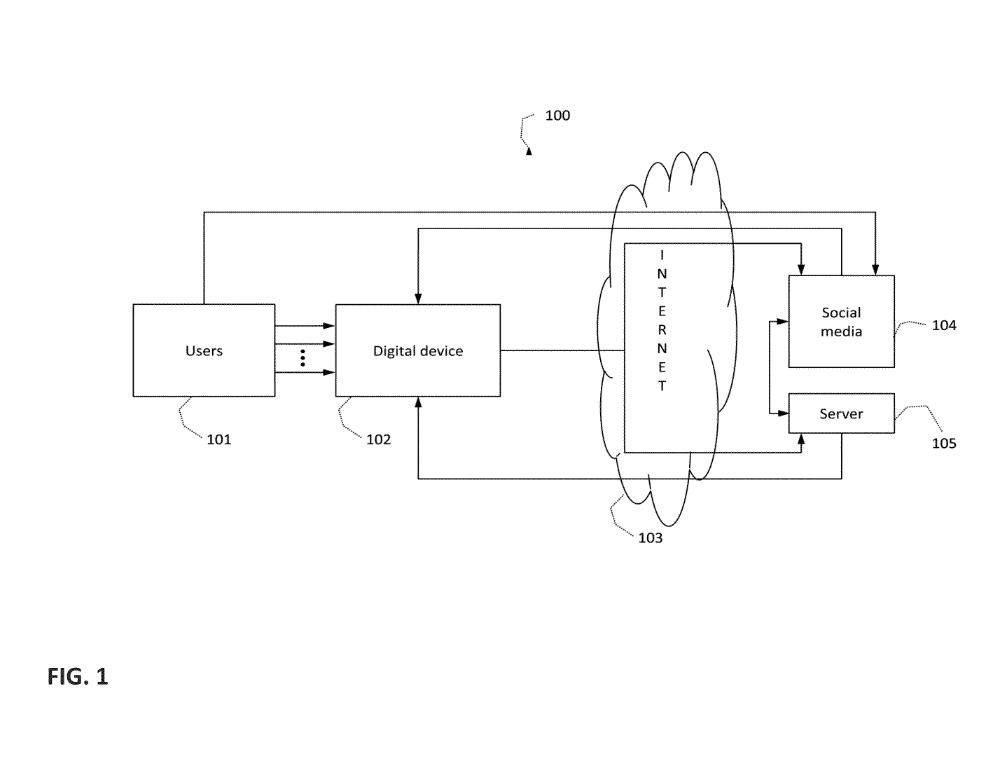

A system 100 for supporting collaborative photography is illustrated in FIG. 1. Users 101 access a collaborative photography system via a digital device 102 such as tablet computer, smartphone, camera phone, smart TV, handheld camera, laptop, smart glasses with embedded computer, desktop computer, photo booth or a kiosk. A user may be a photographer, a metadata generator or a social media content generator. The digital device 102, in some cases is coupled to a network, shown in FIG. 1 as the Internet 103. The Internet 103 is provided to facilitate remote photographers to collaborate, to facilitate photographers to share digital content on social media 104, to receive digital content from other collaborative photographers, to facilitate photographers to send digital content to collaborative photography server 105, to facilitate photographers to receive digital content from the collaborative photography server 105, and to send authentication information to social media 104.

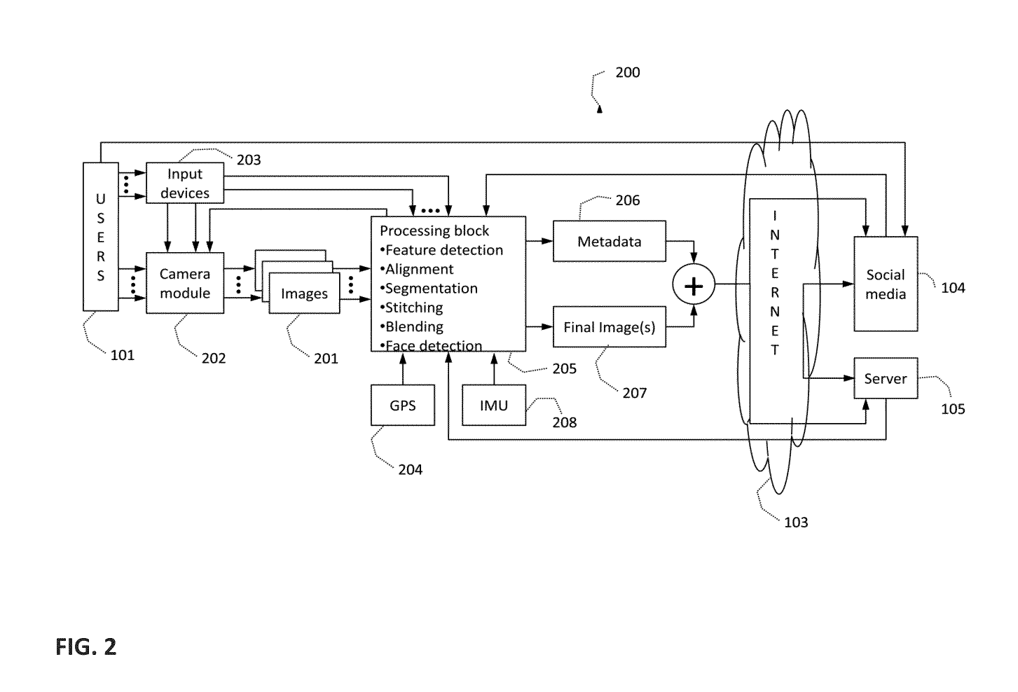

FIG. 2 shows a collaborative photography system 200 and provides details about the digital device 102 of the system 100. The digital device 102 is coupled with a camera module 202, input device 203, Internet 103, optional global positioning system (GPS) 204 and optional inertial and measurement unit (IMU) 208. Input device 203 may be a keyboard, a pointing device such as a mouse or a touch screen, a camera and buttons. Input devices 203 are provided to facilitate users 101 to send instructions to the camera module 202, to provide input to processing block 205, to generate metadata 206, to perform actions on a final image 207, and to enter authentication information for accessing social media 104. The Internet 103 is provided to facilitate transmission and reception of digital content. Digital content may be a digital image 201 and 207, text (including metadata 206), analytics data, or any other form of digital data. The group of collaborative photographers 101 communicates with the camera module 202 and takes multiple photographs 201. These photographs 201 are sent to the processing block 205 which also receives additional input from one or more collaborative photographer(s) 101. GPS 204 and IMU 208 are provided to facilitate generation of the final image 207. GPS provides the location information and IMU provides real-time information about the camera's orientation and motion. In some implementations, the IMU may include an accelerometer and a gyroscope. The gyroscope provides information about rotation along role, yaw and pitch axes, whereas the accelerometer provides information about translational acceleration of the phone/camera at a certain instant which could then be used to find the updated position of the camera. Hence, the system may compute how much the camera was rotated and translated by each photographer just by getting the raw data from the IMU. The final image 207 along with the metadata 206 generated by the processing block 205 is transmitted over the Internet 103 to the collaborative photography server 105 and social media 104.

Executing on a digital device 102 is a collaborative photography application for accessing the camera module 202 to acquire the images 201, for accessing the GPS 204 to obtain location information, for accessing the IMU 208 to obtain motion information, for processing acquired information from camera module 202, for processing acquired information from the GPS 204, for processing acquired information from the IMU 208, for processing acquired information from the users 101 via the various input devices 203, for detecting faces and for obtaining tagging data from the users 101, for accessing the Internet 103 to share digital content on social media 104 and with collaborative photography server 105, and to receive digital content from the server 105. In some cases the application may include several interface screens which allow users 101 to interact with the system. Specific details of these interface screens are discussed below. In some implementations, each of the interface screens may include a back button to navigate the user to the previous screen, a bar along the borders of the display where multiple interaction options can be placed such as side bars, and top and bottom bars, and a central region where the content can be displayed. This content can also act as an interaction mechanism for the user.

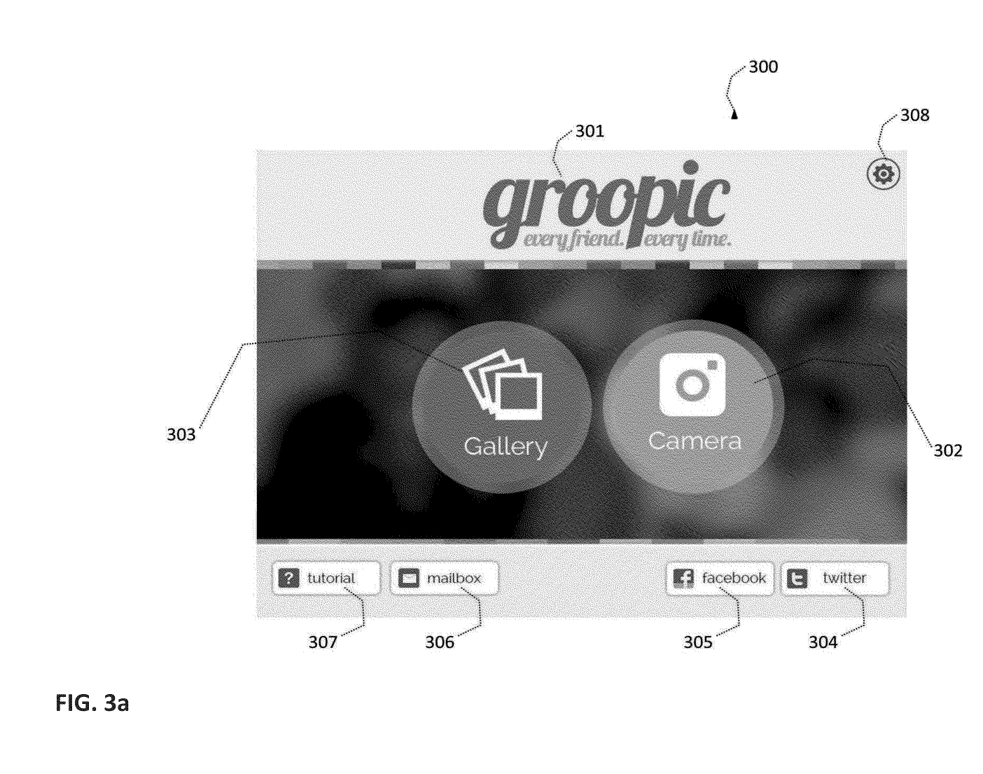

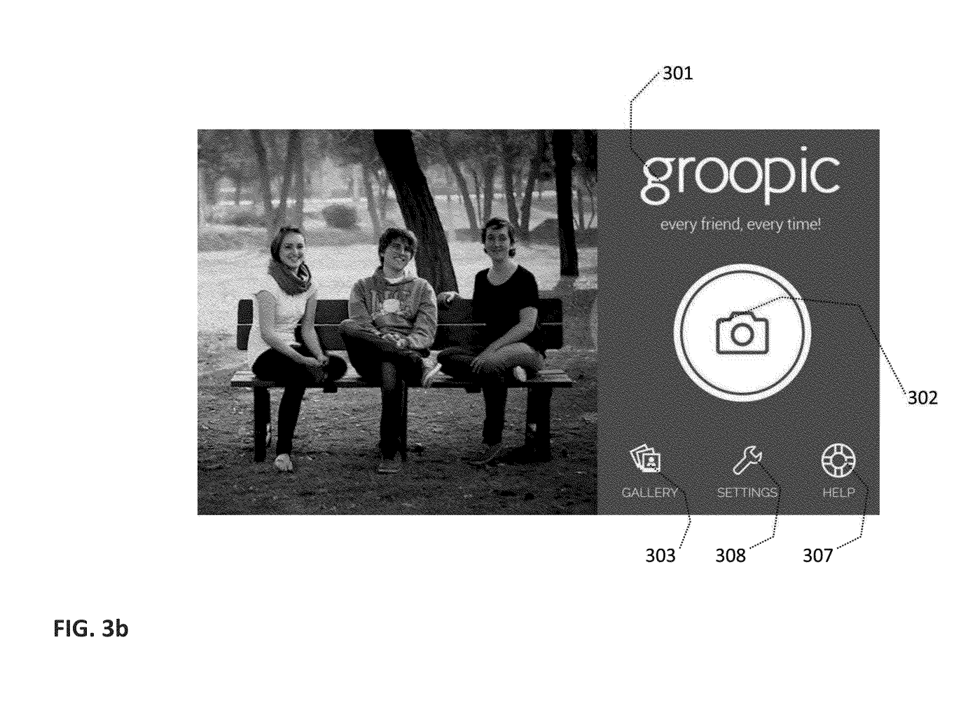

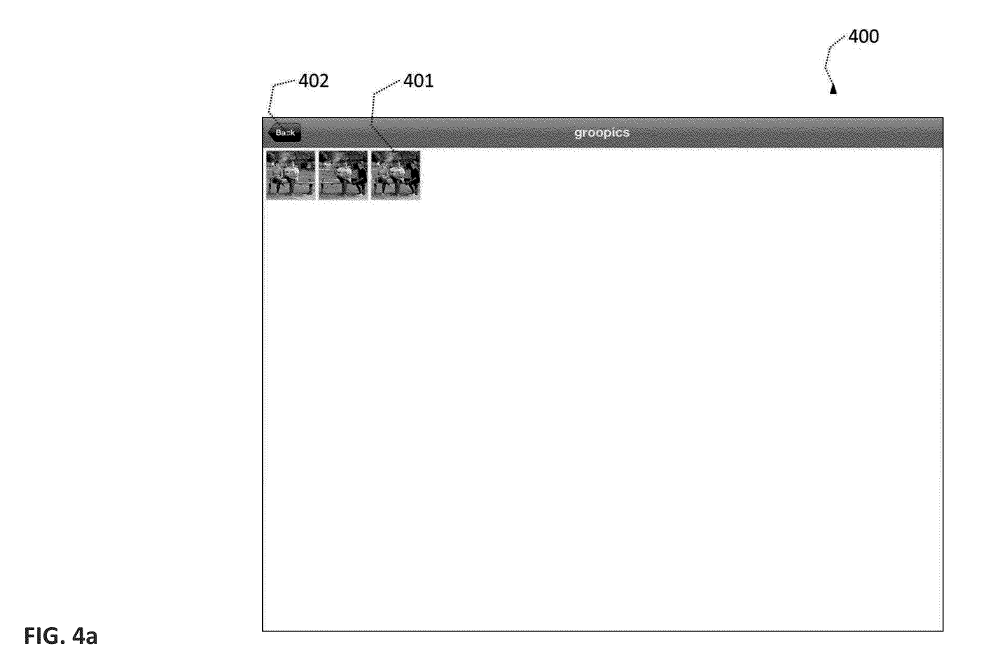

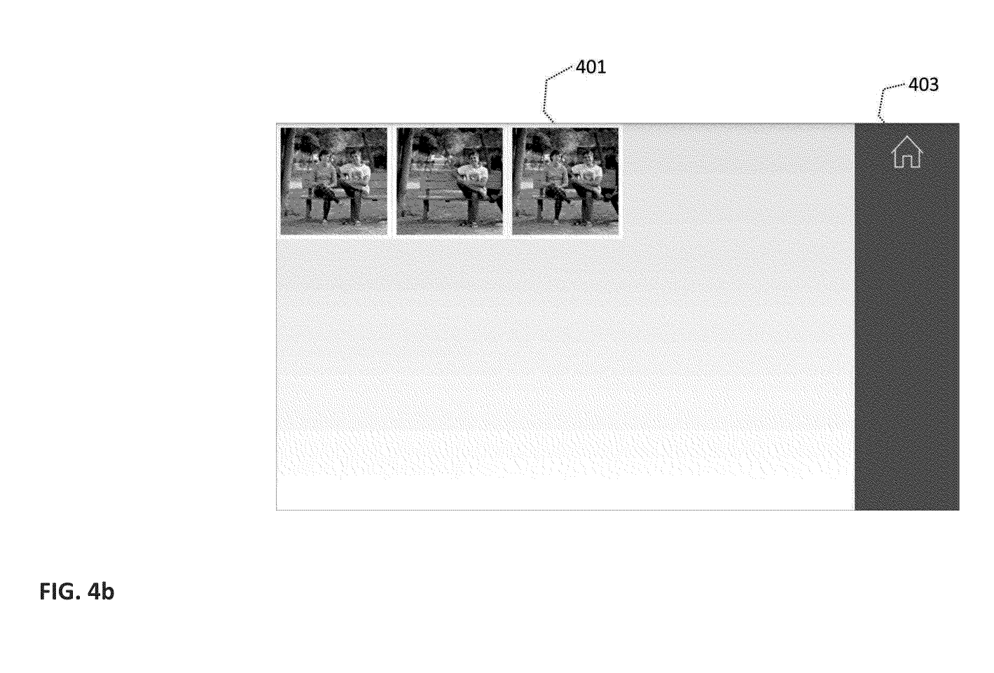

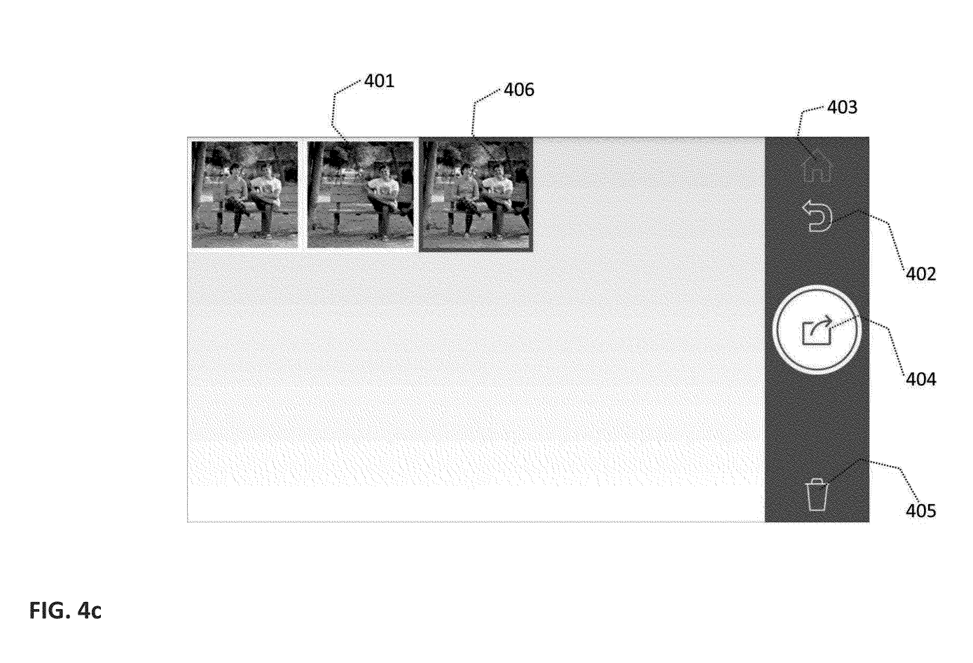

In some implementations of the present invention, the main screen 300 of the collaborative photography system may be as shown in FIG. 3a. This screen exposes several key functionalities of the system to the users 101 and allows them to navigate through one or more user interface screens. At the top of the main screen 300 is a logo and a tag line 301 informing the user about the application name and one of its functionalities. In some implementations of the present invention, the user may want to access the camera module 202; this can be done using the camera button 302 on the main screen 300. In some implementations of the present invention, the camera module 202 can be accessed by using a camera button on the digital device 102 itself (not shown). In some implementations of the present invention, the user may access already taken images (201 and 207) via a Gallery button 303 on the main screen 300, which may cause a gallery screen 400 to be displayed as shown in FIG. 4. A preview button (not shown) on the digital device 102 itself may also lead to the gallery screen 400. In some implementations of the present invention, the main screen 300 contains buttons to allow a user to access social media 104, these include a Twitter button 304 and a Facebook button 305. The main screen 300 may further display buttons or a drop-down list to access other social media sites, including but not limited to LinkedIn, Pinterest, MySpace, Google Plus+, DevianArt, LiveJournal, Tagged, Orkut, CafeMom, Ning, Meetup, myLife, Multiply, and Tumblr. There are a number of other buttons that may be on the main screen 300, such as a help button, a feedback button, and settings button 308. In some implementations, the help button may be a tutorial button 307, which when clicked will show help information which could be in the form of digital content. In some embodiments, the feedback button may be a mailbox button 306 which when clicked allows the user to send a feedback to the server 105 of the application. In some cases, the settings button 308, when clicked, navigates the user to another user interface that will provide functionalities to change the behavior of the application.

In some other aspects of the present invention, the main screen 300 of the collaborative photography system will look like as shown in FIG. 3b and has only following: logo and tag line 301, camera button 302, gallery button 303, help 307, and settings button 308.

The gallery button 303 may open another user interface illustrated as a gallery screen 400 as shown in FIGS. 4a, 4b, and 4c, where images already accessible to the application are presented to the user. These images include but are not limited to images taken by individual users 101, final images 207 generated by the application, images that are generated after applying additional filters, and images received from other sources, including but not limited to the Internet 103, social media 104, and other means of communication. All these images may be stored in a separate memory block which in turn may be stored in any appropriate storage medium, including but not limited to internal memory of a device, attached additional detachable storage, external storage accessed via any communications, or stored on an cloud system accessed via the Internet 103 and the collaborative photography server 105. The memory block may also be stored on social media 104 accessed via the Internet 103 and the collaborative photography server 105.

In some implementations of the present invention, thumbnails of these images may be presented to the user. These thumbnails may be sorted in a grid 401 based on date of acquisition. In some implementations, these images can be sorted based on their content, their size, their metadata, or any other sorting mechanism deemed useful, including user-specified arrangements. One or more images may be selected simultaneously by clicking on the thumbnails using a pointing device or by tapping on the screen of a digital device. In some implementations, the gallery screen 400 may have a delete button 405, which is enabled for selection when the user 101 selects one or more image thumbnails. The delete button 405, when selected, may remove the content of all the selected images and their associated metadata from storage; alternatively, the selected images may be removed from consideration by the image application but may not be removed from storage. In some implementations, the gallery screen 400 may have a share button 404 which allows sharing all the selected images. The user may specify a network or other communication channel by which the images may be shared. In some implementations, in addition to showing photographs by the current user, the gallery may also show other digital content contributed by collaborative photographers through the use of the application or by using other communication and data transfer mechanisms. In some implementations, the digital content may also include videos containing sequences of images. In some implementations, the gallery screen 400 may have a back button 402, which when pressed will return the user 101 to the previous screen that the user was on, which may be the main screen 300 or may be another screen herein described. In some implementations, the gallery screen 400 may have a home button 403, which when pressed will navigate the user 101 to the main screen 300. In some cases of the present invention, upon selecting a specific thumbnail, the user 101 may be navigated to another interface that will provide details of the digital content, such as the interface 500 described below.

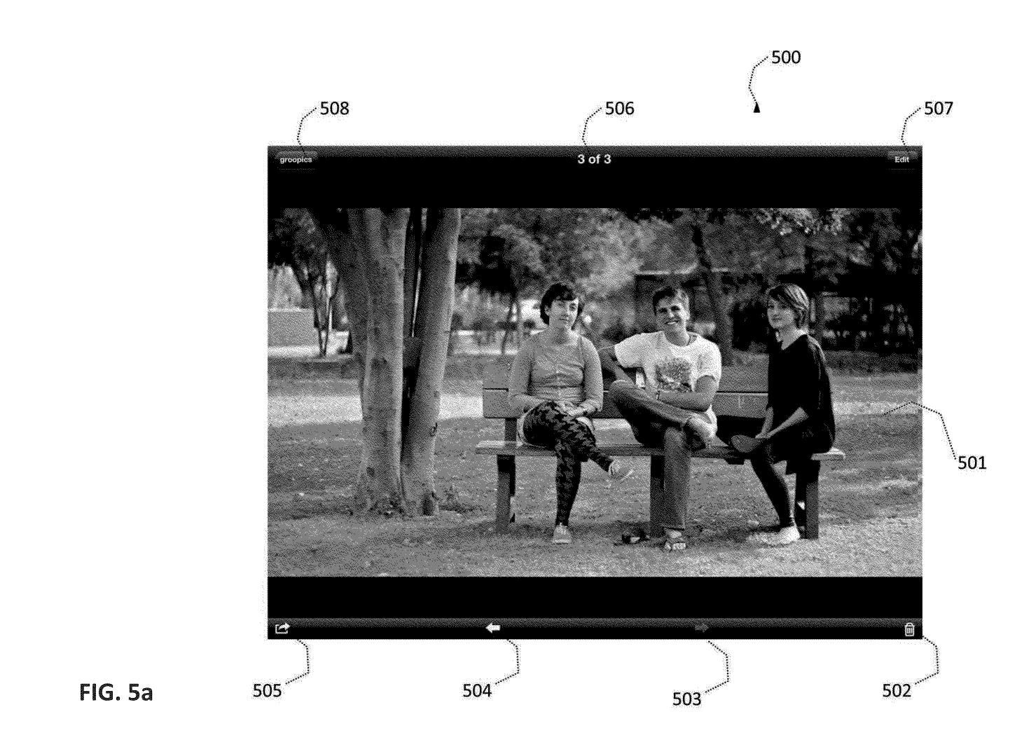

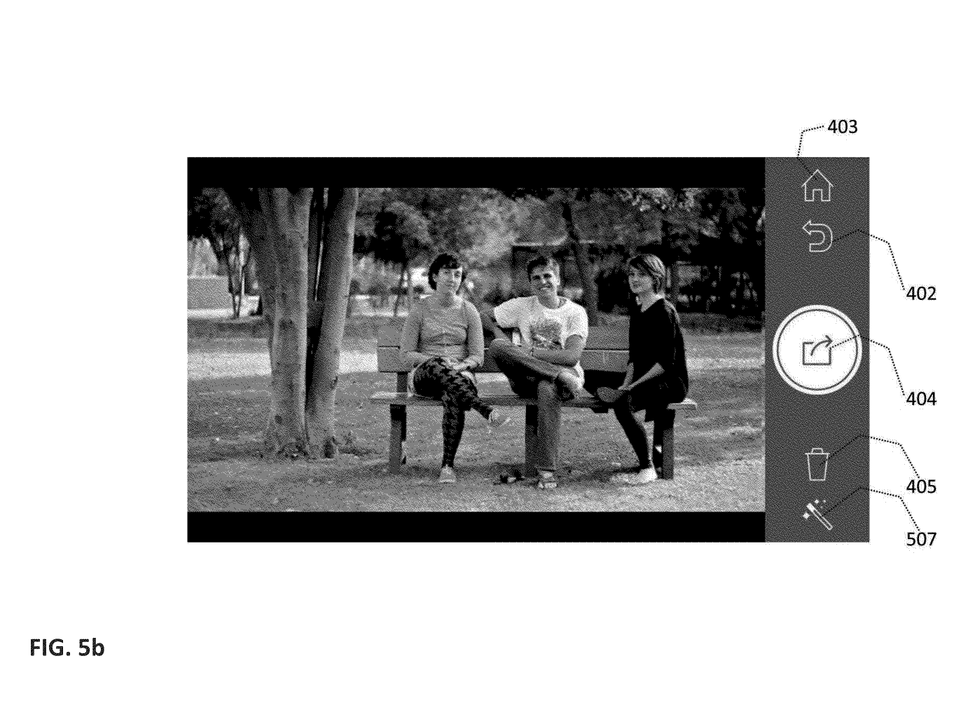

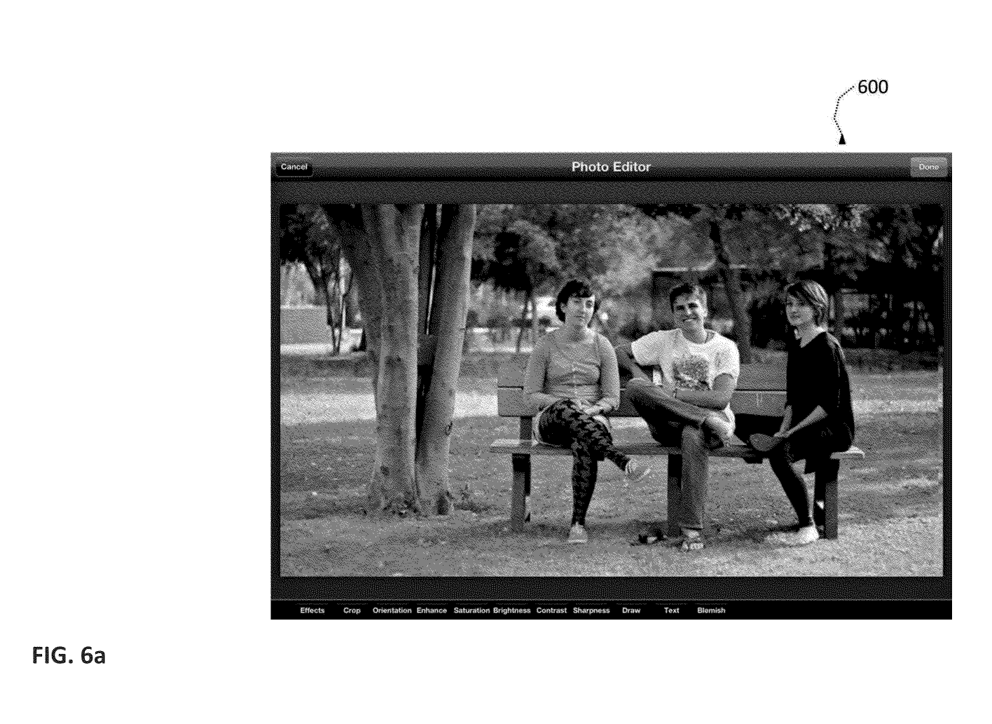

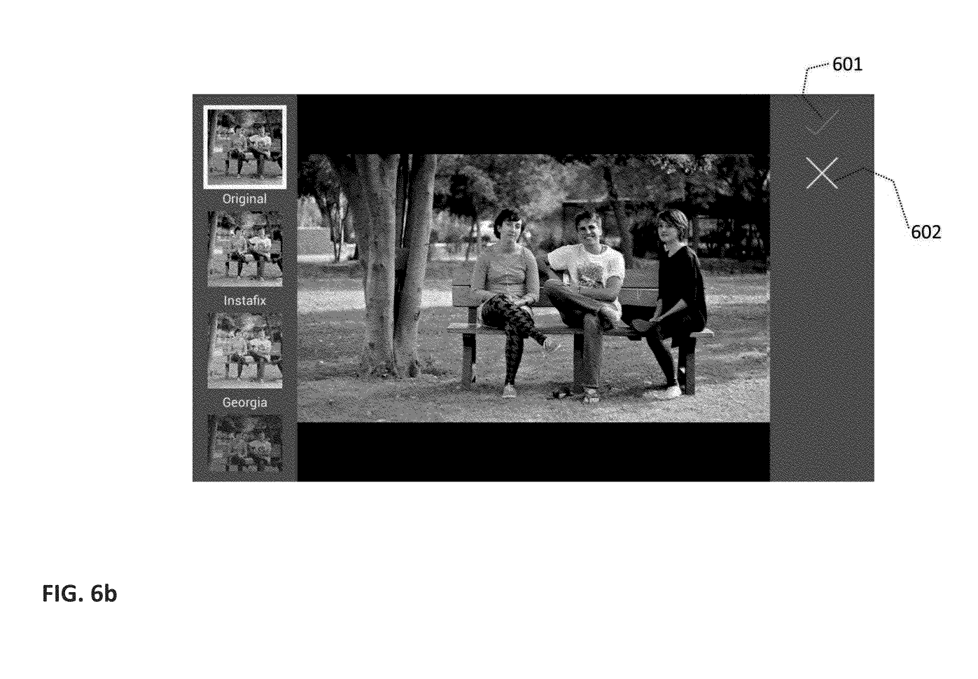

When the user 101 accesses the digital content via the gallery as described above with respect to FIGS. 4a-c, interface 500 (see FIGS. 5a and 5b) may be presented to the user 101 allowing the user 101 to view, analyze, process, edit, discuss, stream, and share the digital content. In some cases the digital content appears at the center of the digital device's display unit 501. In some other cases digital content can appear along the border, in some other cases the digital content can appear in the center of the display interface. The interface 500 can be used to delete digital content using the delete button 502, or shared on the social media 104 via the share button 505, or can be edited using the edit button 507. The edit button 507, when pressed, may open another interface called the edit interface 600 (see FIG. 6) that will allow the user 101 to modify the digital content by applying various signal processing filters and through various signal editing tools. In some implementations the edit interface 600 (shown in FIGS. 6a and 6b) will store both the original digital content as well as the modified copy of the digital content on the available storage. In some implementations the image content of the digital content is converted into a lower resolution. In some aspect of the present invention the edit interface 600 may have tick 601 and cross 602 buttons. The tick button 601 when pressed creates a copy of the image, applies the filter on it, and stores it on the available storage. The cross button 602, when pressed, navigates the user back to the gallery interface 500 without performing any modifications on the image. The user 101 can also navigate to other available digital content through the navigation mechanism which includes, but is not limited to, right arrow button 503 and back arrow button 504, swipe on the screen, using an assigned button on the input interface, clicking around certain regions of the display interface, and using gestures.

The gestures-based natural user interface of the present invention includes but is not limited to hand gestures, head gestures, face gestures, tilt gestures, eye gestures, lips gestures, and limb gestures. Head and face gestures include but are not limited to looking in a certain direction, tilting the head in a certain direction, rotating the head in certain direction, or moving the head in a certain pattern. Eye gestures include but are not limited to moving the eyes in certain directions, blinking, closing the eyes, or opening the eyes. Hand gestures include but are not limited to moving the hand in a certain direction or showing the hand in certain configurations. In some implementations there may be a digital content index 506 which indicates the index of the digital content being displayed on the display unit out of the total count of digital content. In some embodiments the interface 500 may have bars containing buttons along borders of the display area. In other embodiments these buttons could appear and disappear based on user interactions. In some embodiments these buttons may be a part of a drop-down list or inside a menu item. The user 101 can also navigate back to the gallery screen 400 using the back button such as the button 508 shown in FIG. 5.

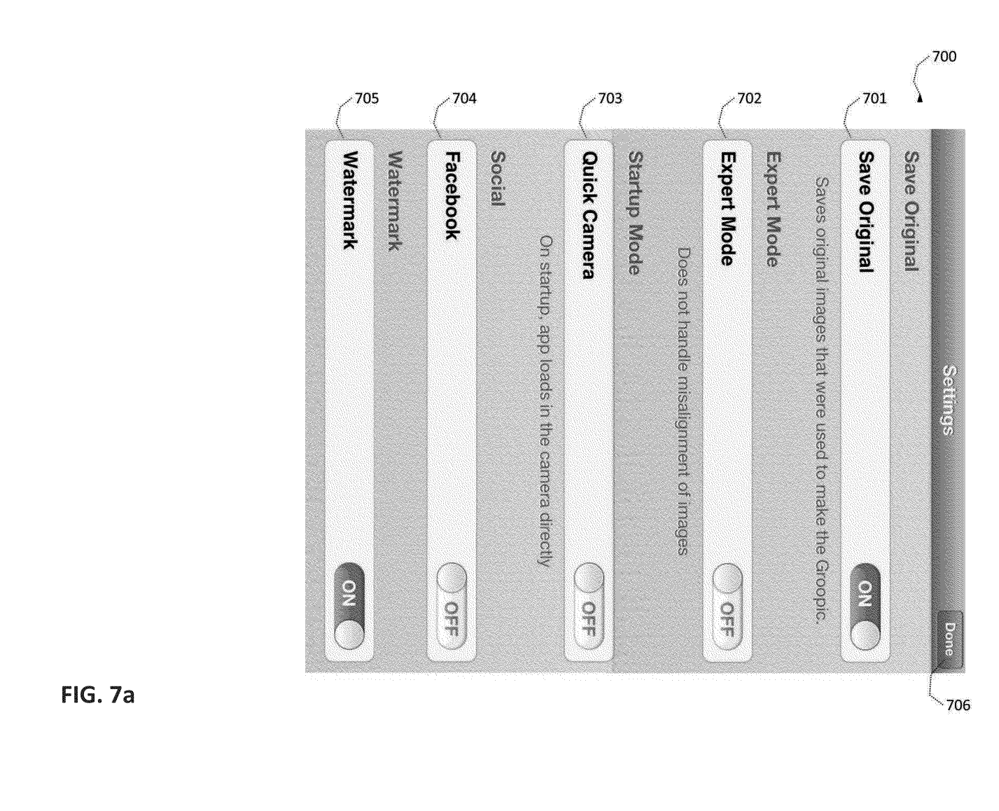

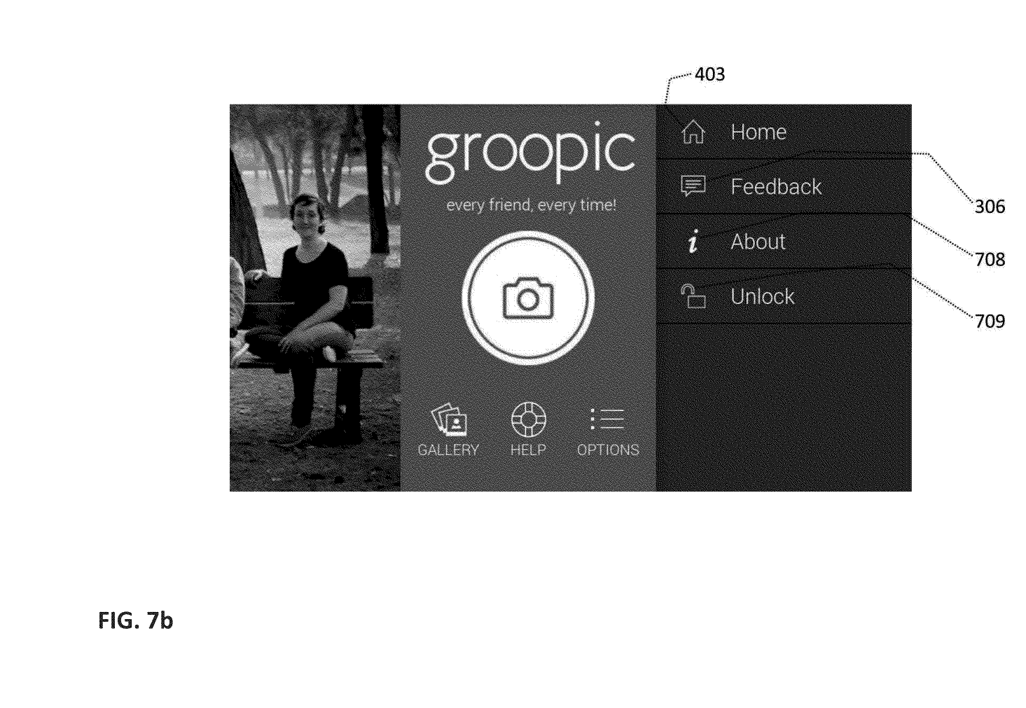

The user of the collaborative photography system 100 can modify several parameters of the system in order to alter the system's behavior according to the user's needs. FIG. 7a shows an interface 700 for modifying the system settings. The settings interface 700 is composed of list of options, each of which can be modified. In some implementations this list includes, but is not limited to, options related to storage of data (for example, “save original” 701, which when activated will store all the images 201 contributed by the individual photographers/users 101, along with the final image 207 generated through the system 100). Other options may include those related to processing 205 multiple collaborative images to create the final image 207—for example, Expert Mode 702, which when activated will disable automatic alignment of images 201 and leave it on the discretion of the user to align them manually. Similarly, the Watermark feature 705, when activated, will add a watermark and security information into the image to identify that the image is a final image 207 obtained through the collaborative photography system 100 or 200. Options related to communication over the Internet 103 can also be set up through the settings interface 700, for example a Social feature 704. In some implementations, the user can also provide authentication information such as user credentials to access various social media 104 services through the system 100 or 200.

In some implementations of the present invention, the settings interface 700 is as shown in FIG. 7b and consists of a feedback option 306 to open the feedback interface, an about option 708 to provide information about the source of the application, and an unlock button 709 to unlock certain features of the systems. In some implementations these features may include advance sharing, in some other cases these features may include an option to unscramble images that has been scrambled by the algorithm to restrict their use.

When the user 101 selects to enable communication to social media 104, the user 101 is presented with another interface (not shown) through which the user 101 can provide login credentials for authentication. These credentials may include, but are not limited to, user login identity, email address, and an associated password. Options related to which interface screens user 101 wants to see every time the system 100 is used, and which interfaces and operations should be bypassed can also be setup, such as, for example, quick camera 703, which when activated, bypasses the main screen 300 every time the system is launched. Finally, there is a back button, for example, the done button 706, which will take the user back to the previous interface.

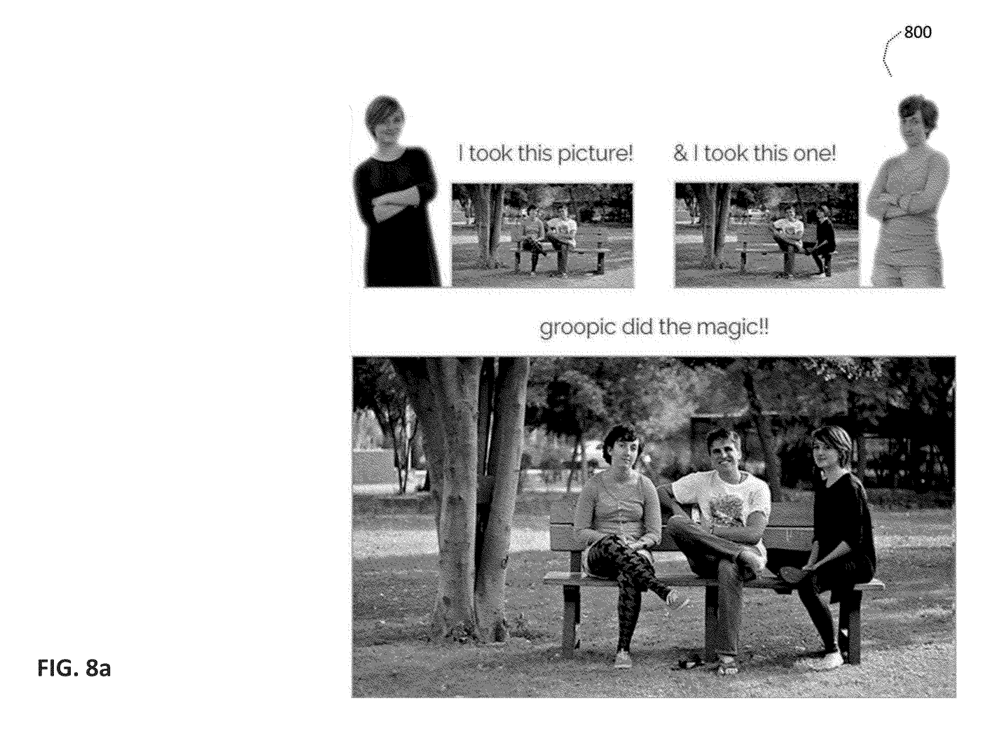

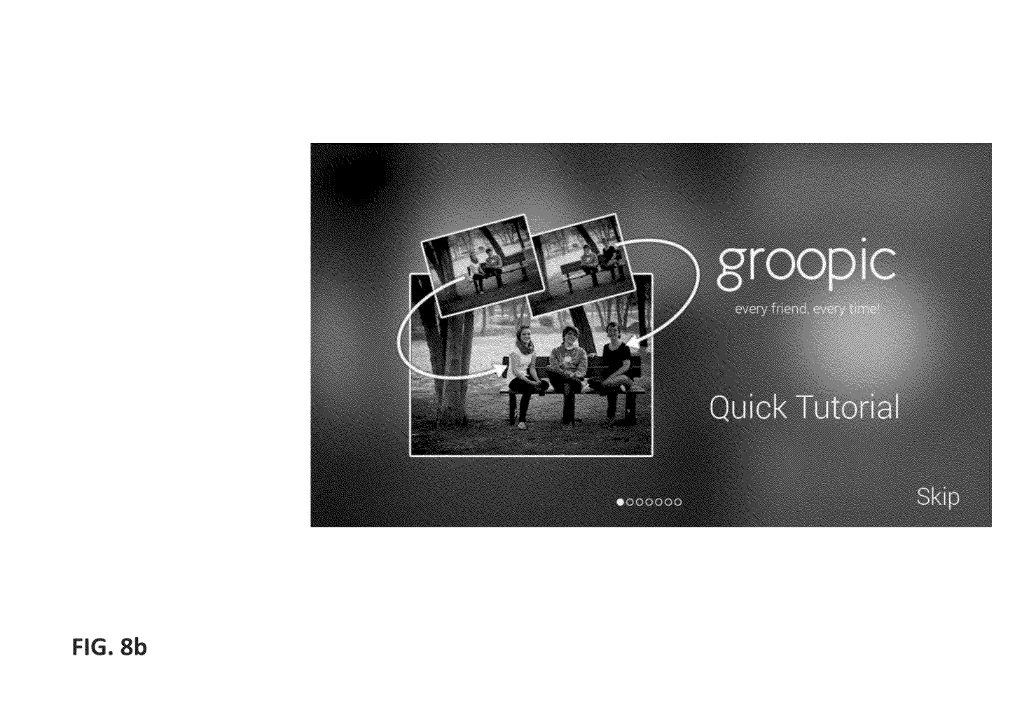

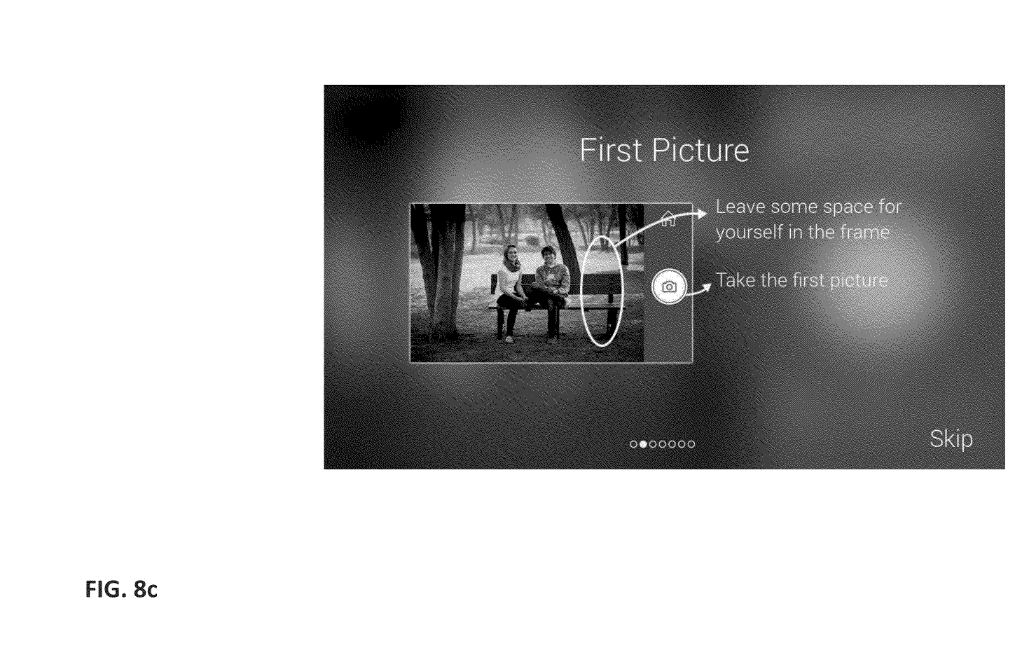

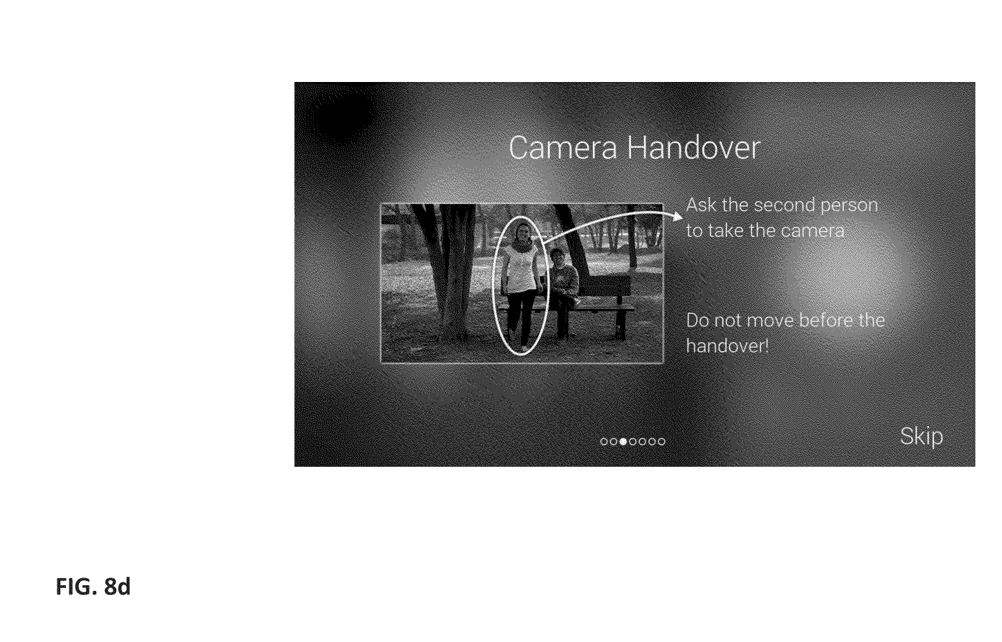

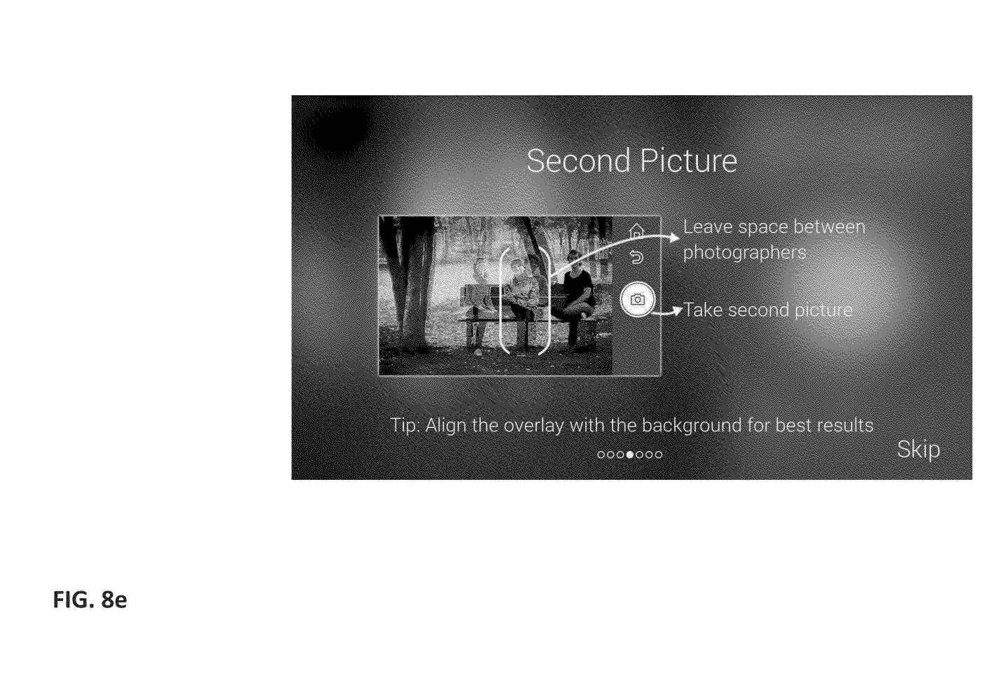

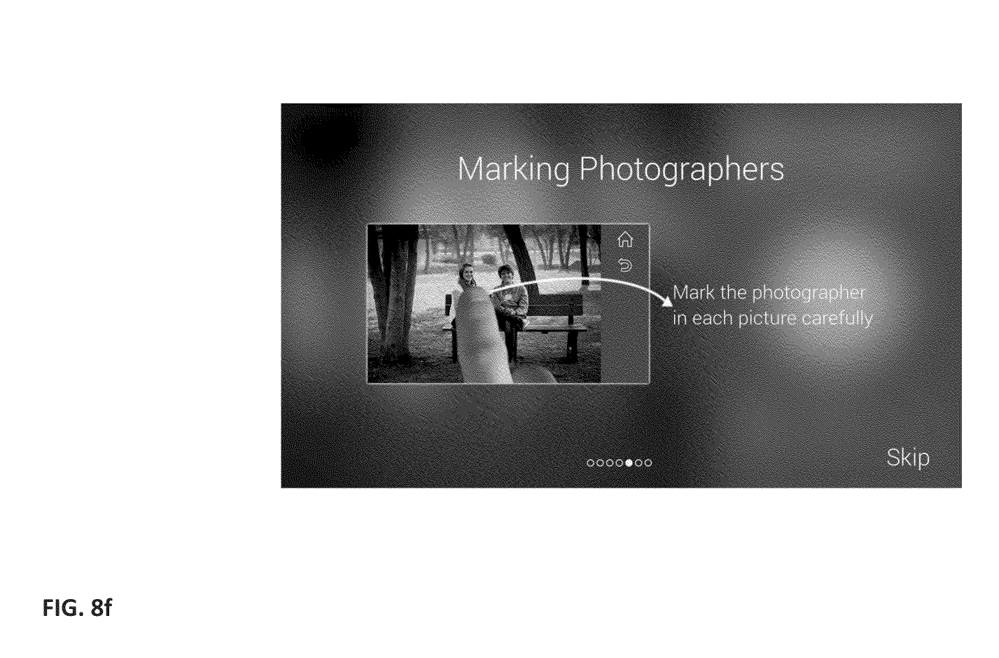

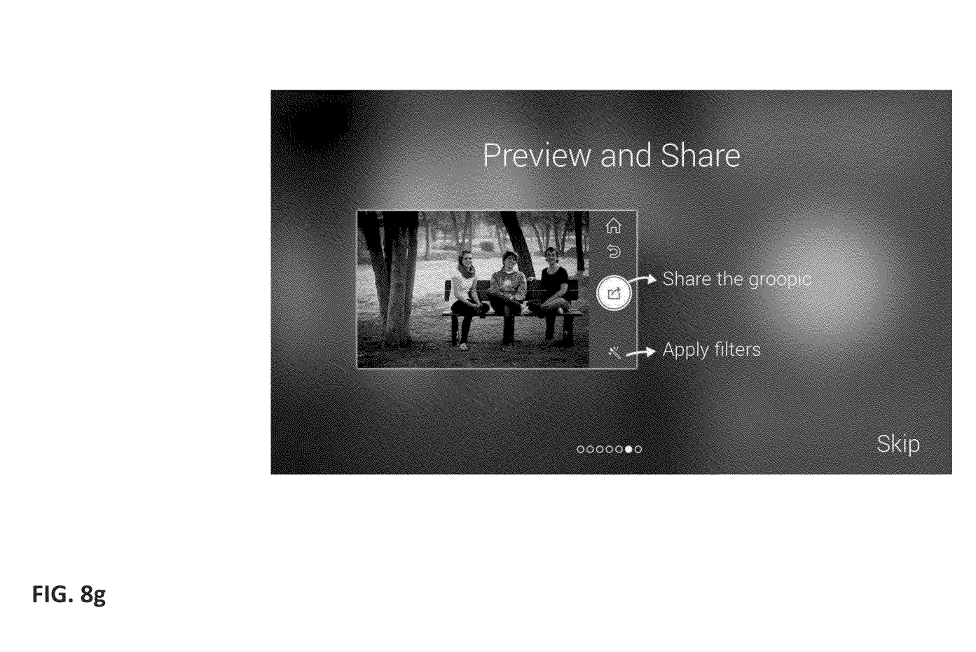

In some implementations of the present invention, a tutorial may be presented to the user 101 via the tutorial button 307 from the main screen 300. In some other cases the tutorial may also be presented via a help button from any other interface of the application. This includes, but is not limited to, interface screens of the application running on the digital device, the interface screen of a website (not shown) and interface screens displayed through social media (not shown). The tutorial is provided in order to train the user 101 regarding how to use the collaborative photography system and apparatus application and to increase his/her knowledge about the usage of application. The tutorial 800 may be digital content that presents to the user 101 already-obtained outputs from various stages of the system with additional supporting digital content and metadata for clarity and increased understanding. In some implementations there may be an interactive tutorial which will let the user 101 use the system and application without involving the core algorithm of the system. In other implementations, the tutorial may be in the form of sequences of images (such as FIGS. 8a-8g) or video. In some implementations, the tutorial may be in the form of some other digital content, such as text and audio.

In some implementations, the collaborative photography system as proposed by the present invention can be summarized as in FIG. 8. In some implementations, two photographers collaborate to create a final composite image or sequence of images. In some implementations, more than two photographers may collaborate to create a final composite image or sequence of images. In some implementations, a single photographer may interact with the scene to create a final composite image or sequence of images by interacting with scene objects.

In some implementations, the first optional step of the collaborative photography may be the planning phase, in which the photographer plans the photography session. In the planning step, the user may decide tentative positions of people, including the photography, and scene objects. The sequence in which multiple photographers will use the digital device 102 may also be planned.

Following the optional planning step, the first collaborative photographer takes a picture using the camera associated with the digital device 102. Next, the first collaborative photographer hands over the digital device 102 to the next photographer, a second and different user. For this handover, the next photographer, who in some cases may have been part of the previous picture, leaves the scene and takes the digital device 102 from the previous photographer, while the previous photographer joins the scene. To ensure that the final collaborative image or sequence of images contains all the photographers, the previous photographer joins the scene at a position other than that of any previous photographers. If more than two photographers are used, the handovers continue until each of the photographers has taken a picture (although some implementations may be limited to two photographers for a single collaborative shot as described).

The next and the fourth major step of the collaborative photography system is the alignment step. The system presents an overlay of features from a previous image or images to the photographers. These features include, but are not limited to, spatial features, temporal features, frequency domain features, coefficients and basis vectors obtained by applying a unitary transform to the image or sequence of images, and coefficients for some predefined data-independent basis vectors. In some implementations, the photographer (user 101) uses these features to align the current live feed with the previously-taken image or images and then takes another image through the camera associated with digital device 102. In some implementations, the alignment using the overlay features is done before handing over by digital device 101 to the next photographer. In such cases, the current photographer stays in his or her original position from where the picture was taken and keeps the camera in the same position and orientation. The next photographer leaves the group and joins the current photographer. The digital device is then handed over to this next photographer such that the previous image and live view remain as much aligned as possible. After this alignment-preserving device position and orientation is handed over, the previous photographer joins the group. The previous photographer can join the group at any position within the field of view of the imaging device; however, in some implementations, the position should be other than the position at which the current photographer was previously standing.

In some implementations, the system allows repeating the third and fourth steps, described above, as many times as the users 101 prefer. The system then performs the fifth step, in which all the photographers are further aligned automatically based on common features in the images and then the images are combined to obtain a single large image or sequence of images. In some cases, the photographs are combined without any additional alignment. The final image is then stored in the gallery and can be shared via the Internet 103 or other means as disclosed herein. These steps form a unique system through which photographers are added to the photo in such a way that it is indistinguishable from them having been present in the scene when the photo was taken.

Many variations of the above method are possible. In some implementations, all the steps of the system can be performed by changing scene objects and/or changing the positions of the scene objects. In some implementations, all the steps of the system can be performed by changing both the people and photographers during the collaborative photography session. In cases when one or more scene objects or people change position in the scene during multiple photographs, it is possible that: i) the same object or person appears multiple times, referred to as “multiplicity,” and ii) the person or object is completely removed from the scene, referred to as “invisibility.”

Multiplicity occurs when the region of the images selected (either selected automatically by the algorithm such as by using change detection or smart face detection, or selected manually such as by using a pointing device or by tapping on the screen) from two or more images contains the same object or person due to their change in position. Since the same object or person is included in the selected region from multiple photos, the final composite contains the same object or person multiple times in the image. This can be understood by using an example of two images as follows. Person A is present in the left region of the scene viewed by the digital device (field of view of the camera), thus appearing in the left region of the first image. After the first image is taken, person A moves to the right region of the scene viewed by the digital device, and then the second image is acquired. This results in person A being in the right region of the second image. If the left region of the first image is selected and the right region of the second image is selected, this could lead to a situation in which person A appears both on the left side and right side in the final composite. Similarly, in the case of more than 2 images, person A can appear more than 2 times in the final composite image. In the case where more than one person and/or object is moved during the acquisition of multiple images, the concept of multiplicity will be extended to more than one person and/or object simultaneously.

Invisibility occurs when the same object or person changes position in multiple photographs and the selected region(s) of the image do not contain portions that include that person or object. Since the same object or person is skipped from multiple photos, the final composite does not contains regions where that person or object is present in the scene. This can be understood if, in the above example, the right region of the first image is selected and the left region of the second image is selected, such that person A does not appear in the final composite image. The concept can be similarly extended to more than two images. In a case when more than one person and/or object is moved during the acquisition of multiple images, the concept of invisibility will be extended to more than one person and/or object simultaneously.

It will be recognized that both multiplicity and invisibility could occur simultaneously in a particular collaborative photography session. Due to the movement of one or more persons and/or objects during the collaborative photography session, one or more person and/or object can appear multiple times while one or more persons and/or objects could disappear, leading to the simultaneous occurrence of multiplicity and invisibility.

In some implementations of the present invention, the final composite image is created by selecting already existing images in storage, referred to as “group again.” In group again, the user can select images taken in the past such that there is some spatial overlap between those images. In such cases, first three steps of the collaborative photography outlined above are not required and the system starts processing from the fourth step of aligning images and then performs all the remaining steps of stitching and blending with or without requiring additional input from the user.

An aspect of the present invention, referred to as Space Invariant Collaborative Photography or as “remote group picture,” allows the collaborating photographers to be spatially located at different locations such as at different physical addresses. This aspect of the present invention allows having a group picture with people that are spatially located at different places.

In order to take a remote group picture, collaborating photographers at different locations each first take an empty picture of their site, including the background scene, but no people. Following that, each photographer then takes one or more group pictures of the scene including the people and objects at their location that are to be included in the collaborative image. The pictures are then sent to a single device, such as a device of one of the collaborating photographers. The remote group picture algorithm of the present invention automatically combines such remotely taken photographs into one single group picture such that it reduces or eliminates visual artifacts.

This aspect of the present invention first removes the people in the scene by applying frame differencing between the group pictures and the picture of the site without the people, using the pictures contributed from that particular site. Once pictures from all the sites are processed, the algorithm selects one of the pictures as the base reference image for the final composite pictures. First, it estimates the position of light source in the scene contained in the reference image, then all the segmented people are re-lighted using the extracted light source. The re-lighting process computes the new value of shading for each pixel of each person and also computes the position and projection of the shadows of each person in the new scene based on the extracted geometry of the new scene. This gives a new visual appearance to the segmented people, as if they were present under the lighting conditions of the reference image. All the segmented people are then inserted into the reference image such that there is minimal or no overlap between the inserted people among themselves, as well as the people present in the reference image. The final composite image thus contains all the people present in all the images contributed by the photographers. In another aspect of remote group pictures, scene objects could be inserted in the final composite image using the same algorithm.

An aspect of the present invention, referred to as Time Invariant Collaborative Photography, allows the collaborating photographers to be able to collaborate at the same spatial location but at different times, even different days. In such aspect, a first collaborating photographer visits a site and starts a collaborative photography session by taking a picture of a scene and sharing it with the other collaborative photographers. The next collaborating photographer then visits the same site at another time. The live view of this collaborating photographer will have an option of having the features from the image taken by the previous photographer being overlaid on the camera live feed. The overlay feature will help in aligning the next image with the previous image. In some aspects, the camera view is also aided with direction information, indicating how the camera should be positioned for better alignment with the previous picture. In some aspects, the directional aid is in the form of visual indicators, such as arrows on the screen. Such visual indicators can be obtained through utilizing metadata such as GPS information associated with the previous image, as well as that of the digital device used by the current photographer. Once the current photographer has aligned and acquired the image, the algorithm then performs the automatic alignment, stitching and blending to create a final composite image. The final composite image will then be made available to the next collaborating photographer. This aspect of the present invention thus allows people visiting the same site at different times to be part of a single composite image. An aspect of the Time-Invariant Collaborative Photography is that group pictures can be created with celebrities and other well-known people. For example, a user could take a picture of a famous person at an event or a party, and later stand next to where that person was standing and then take a next picture. This results in having a group picture with a celebrity without invading their personal space. This use case can be extended, such that a library of celebrity photographs could be provided to a user to integrate the user's own pictures with a given celebrity image.

Another aspect of the Time Invariant Collaborative Photography aspect of the present invention is Augmented Sharing of photographs. In Augmented Sharing, the next photographer can look at one or more of the pictures taken at the same spatial location by other photographers (such as people in the same social network) while they were at the same spatial location in the past. This aspect of the present invention not only allows viewing these shared images, it then also allows the current photographer to use one of these pictures to continue with the next step of time invariant collaborative photography as described above.

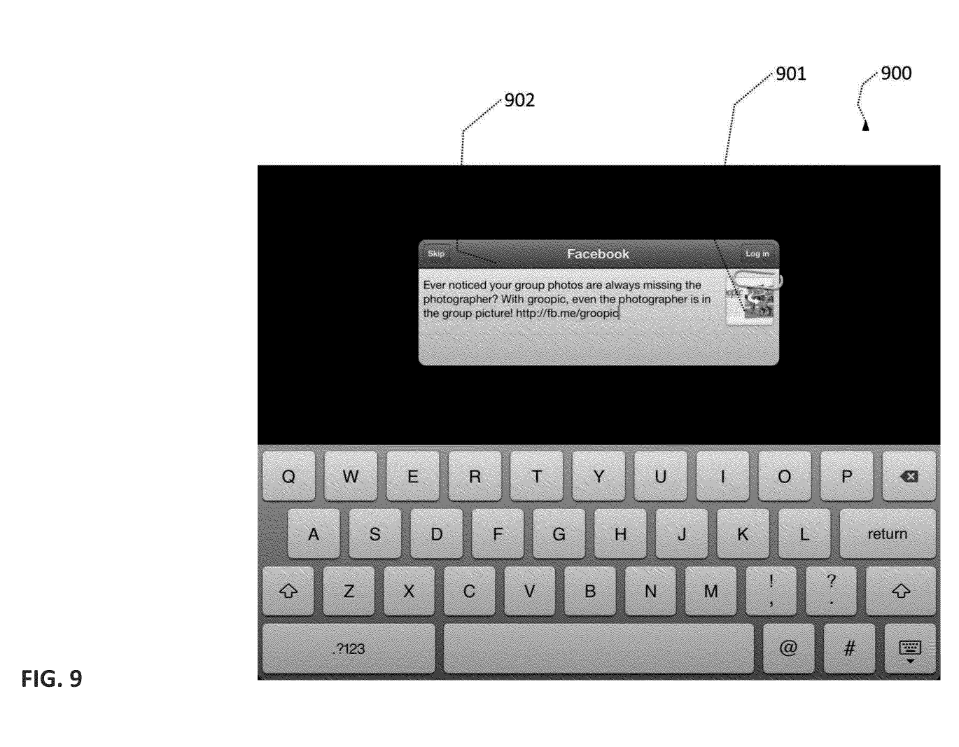

FIG. 9 presents a sharing interface 900 that allows user 101? to share the digital content via a communication medium such as the Internet 103. In some embodiments, digital content available on the digital device 102, or the digital content generated through the present invention including the content generated by users 101, can be shared through the invention. The sharing interface may invoke checks for the availability of the communication network to connect to other digital devices, social media 104 and collaborative photography server 105 via any available communication medium such as the Internet 103, Bluetooth or other short-range radio protocol, multi-media messaging (MMS), simple text messaging (SMS), peer-to-peer connectivity, and client-server connectivity. The sharing interface, based on the type of sharing method selected, performs the steps required by the method-specific protocol. These may include, for example, searching for the requested node, checking its availability, performing any required authentication procedure, preparing desired data packets, transmitting the prepared data packets, and verifying their successful reception at the other end of the communication channel. In some embodiments, the interface 900 allows attaching image content 901 as well as allowing the user 101 to associate a description with the content 902. Additional metadata such as face locations and tagging information (not shown) may also be shared through the same sharing interface.

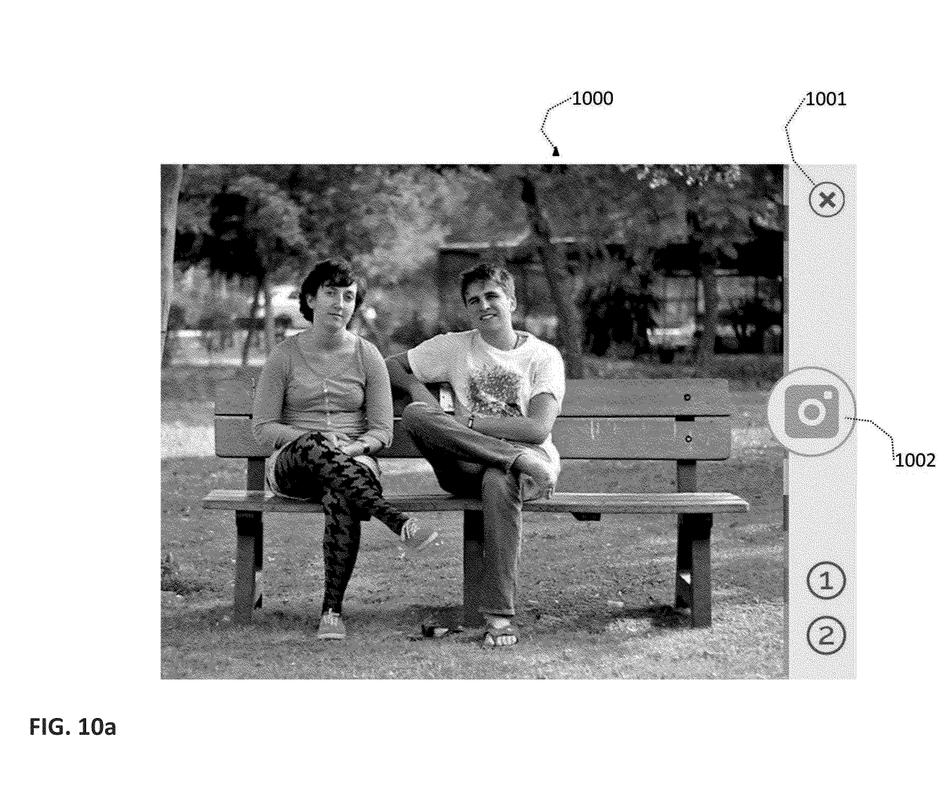

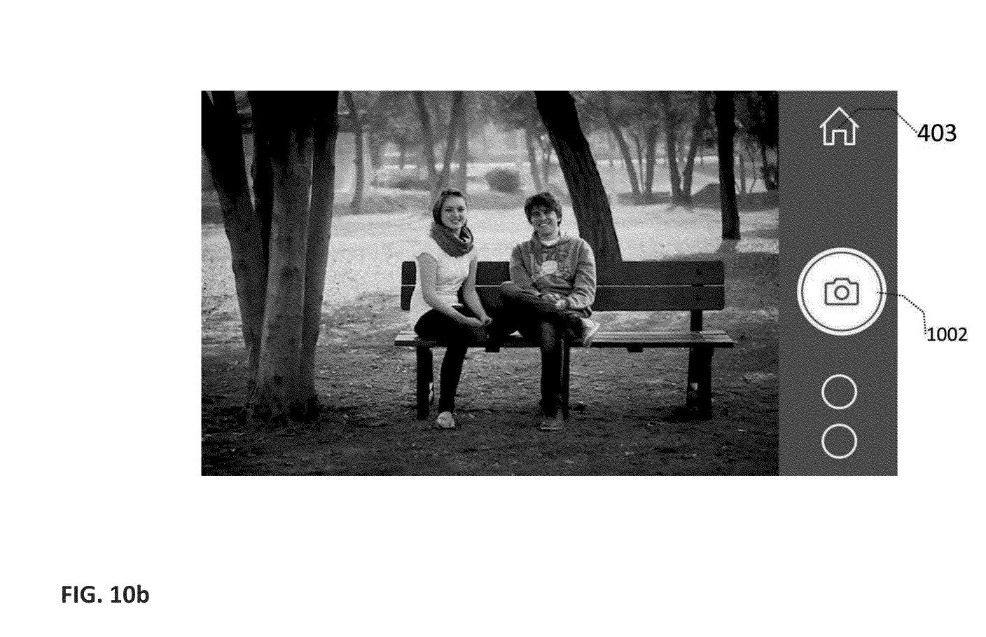

In some implementations, the camera button 302 on the main screen 300, when pressed, starts a new collaborative photography session. FIGS. 10-14 show various steps facilitated by a collaborative photography system. FIGS. 10a and 10b show an interface 1000 in which a live camera feed is shown to the user for taking a photograph. The cross button 1001 can be pressed at any time to terminate the collaborative photography session. The camera button 1002 can be used to acquire the image through the camera module after auto-focusing, which will then be stored for further processing. In some implementations, the user 101 can also select a location or region on the image to be focused by providing an input via the input device 203.

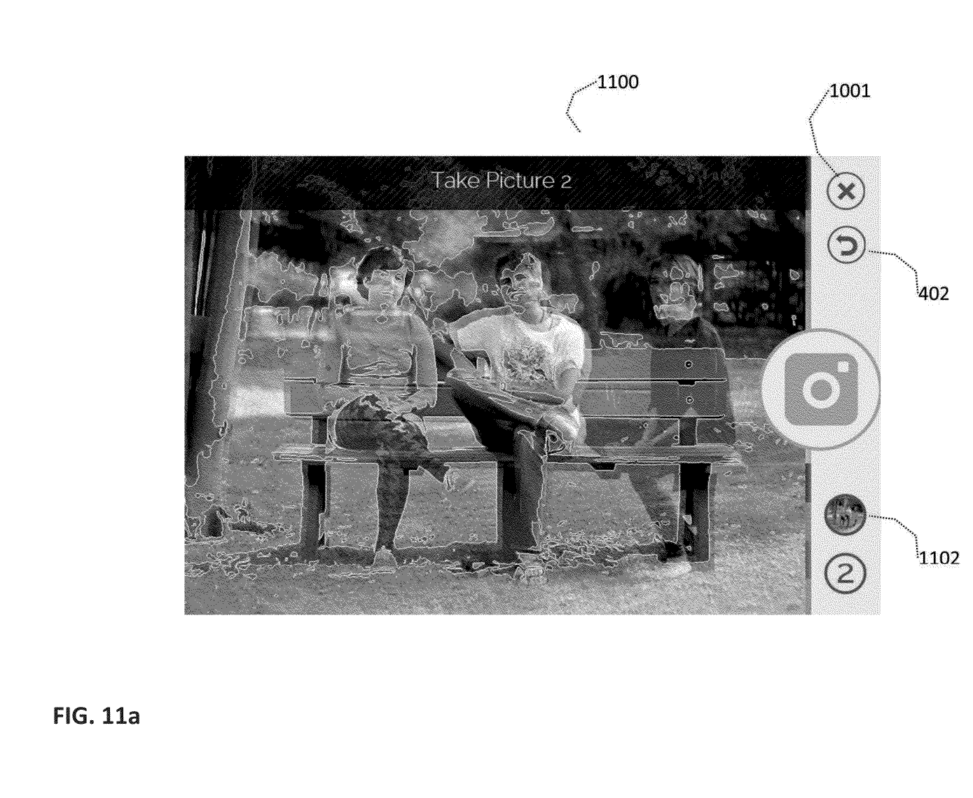

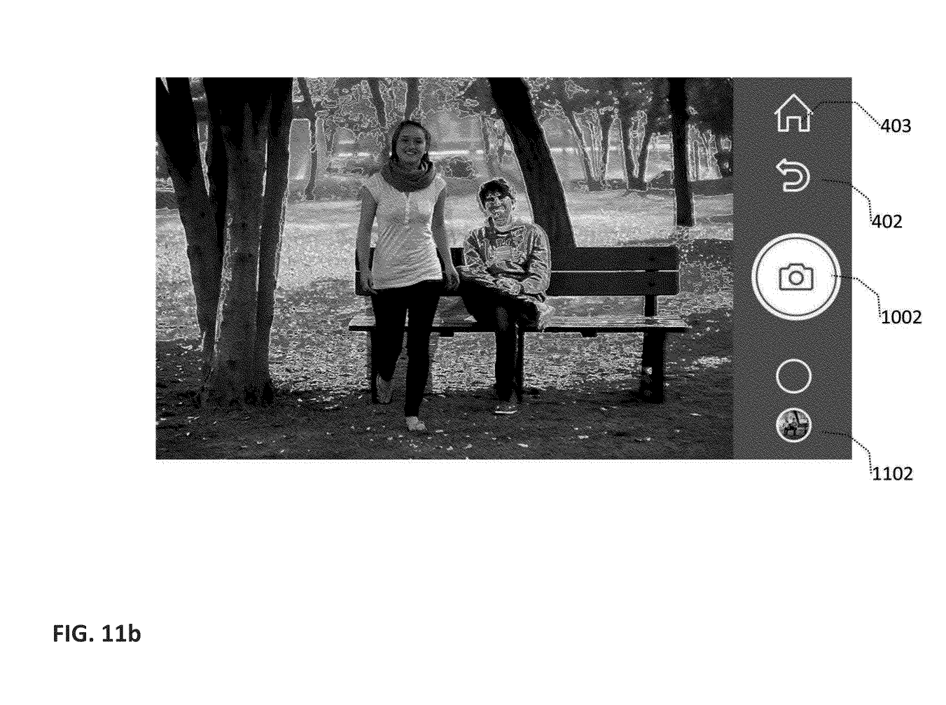

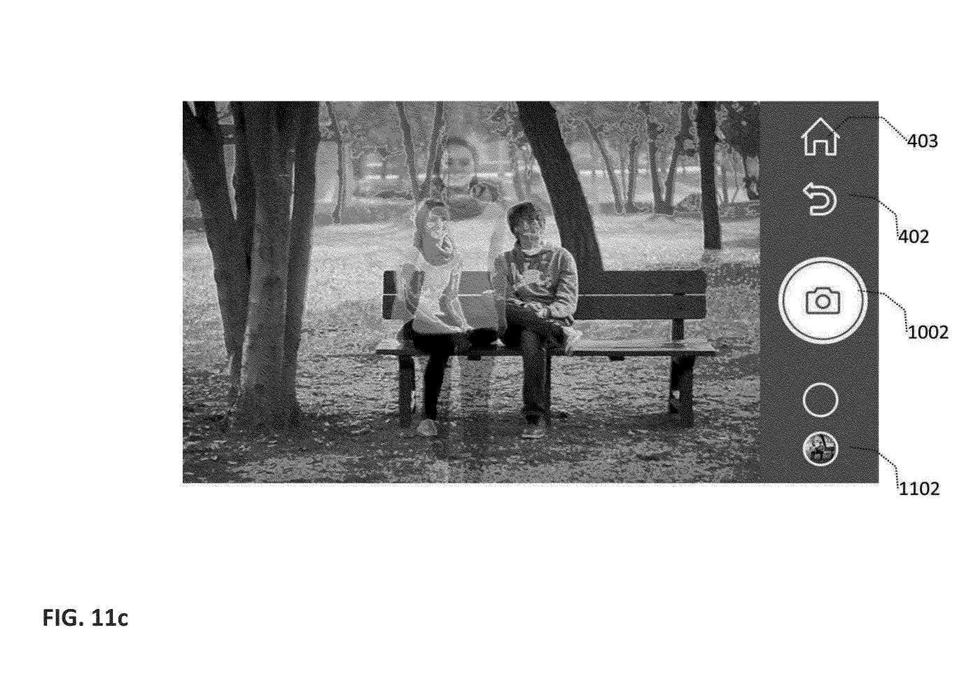

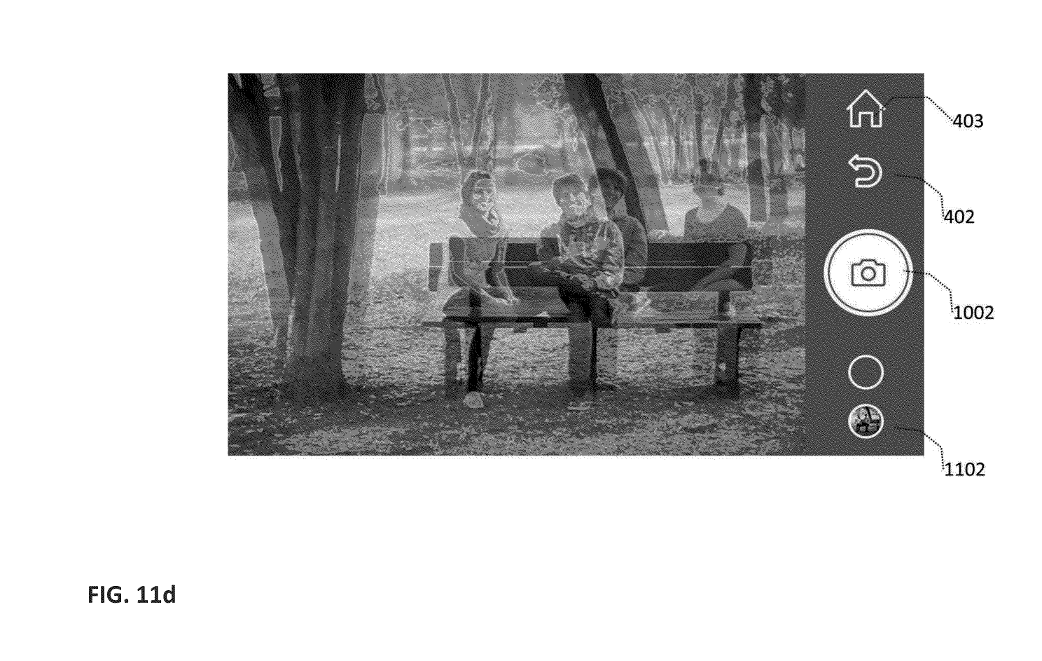

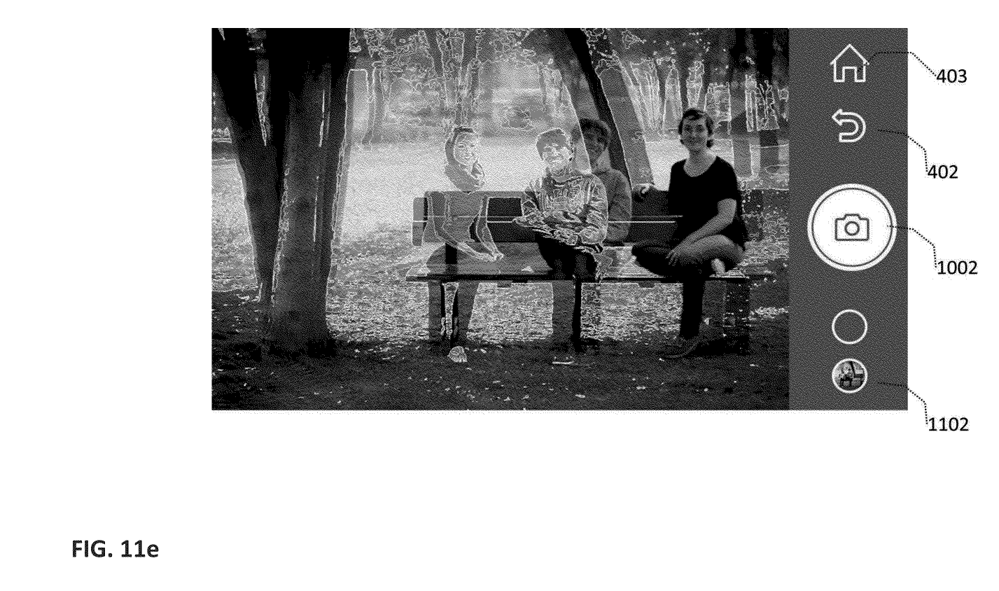

Once a first image has been taken by pressing the camera button 1002, the processing on the acquired image may start automatically while the user prepares to take further images. FIG. 11 shows an interface 1100 to be used by the next photographer, who can see the image and/or features from the image or images taken by the previous photographer overlaid on the current live feed. The overlay helps the next photographer in aligning the live feed with the previous photograph, thus the same scene can be imaged multiple times during, which the previous photographer can be included in the scene. This will allow a collaborative picture that also includes the previous photographer. Similarly, additional objects can be added in the scene during a single collaborative photography session. In some implementations, the current photographer takes the picture and keeps the camera at its original position, waiting for the next collaborating photographer. Once the next photographer (who can be in the group of people imaged in one of the pictures) arrives, the camera is handed over to this new photographer for the next photo. The handover is performed such that the camera is moved as little as possible, and the alignment of the current overlay with the previous image is maintained as much as possible. This aspect of the invention is referred to as an alignment-preserving handover, as shown in FIGS. 11b and 11c (with different levels of image overlays). Once the handover is complete, the previous photographer leaves his or her position and takes a new position within the group as shown in FIGS. 11d and 11e. In some cases, some scene objects can also be removed from the scene during a single collaborative photography session

In some cases, the camera can also be moved to capture and include other scene parts, resulting in a larger coverage of scene. This aspect of the invention can be interpreted in two ways. In some aspects it can be considered as a generation of a group panorama where a high-resolution image is obtained by stitching together multiple images. In a group panorama, the multiple images are not the same view of the scene; instead they are partially overlapping images such that each new image covers or captures an additional part of the scene. Unlike conventional panorama applications commonly referred to as 360 panorama or full spherical panorama, here the aspect of panorama is not in terms of angular movements. Instead, the aspect of the invention deals with translational movements in either horizontal or vertical directions. In any photography session, the movement can either be all horizontal or all vertical or may include both. A new picture is added into the final composite image when the overlap between the previous and the image observed by the live view is less than a certain threshold. In some aspects, this threshold could be user-dependent such that the user can decide when to take another photograph. In some other aspects there could be an automatic mechanism through which a new picture is acquired when the amount of overlap is reduced to a certain threshold, such as 25% or less. The process of translating and adding photos in the panorama can continue up to any number of iterations desired by the user or specified in the settings of the system.

In some implementations of the group panorama aspect of the invention, the system strictly assumes no angular movements, and any such movement introduced by the user is automatically rectified to obtain a rectified view of the scene. In some implementations, the rectification could be ortho-rectification. The rectification process may be based on either analyzing features in the image or on using IMU data or both. According to another aspect of present invention, as well as the group panorama aspect of the present invention, the same person can appear in two or more pictures at two or more different locations in the scene covered by the photograph, resulting in the multiplicity aspect of the present invention. The button 1101 allows the user 101 to revert back to the previous step at any time during the collaborative photography session. The preview 1102 indicates that the previous image is already acquired and the current image can be aligned with the previous image.

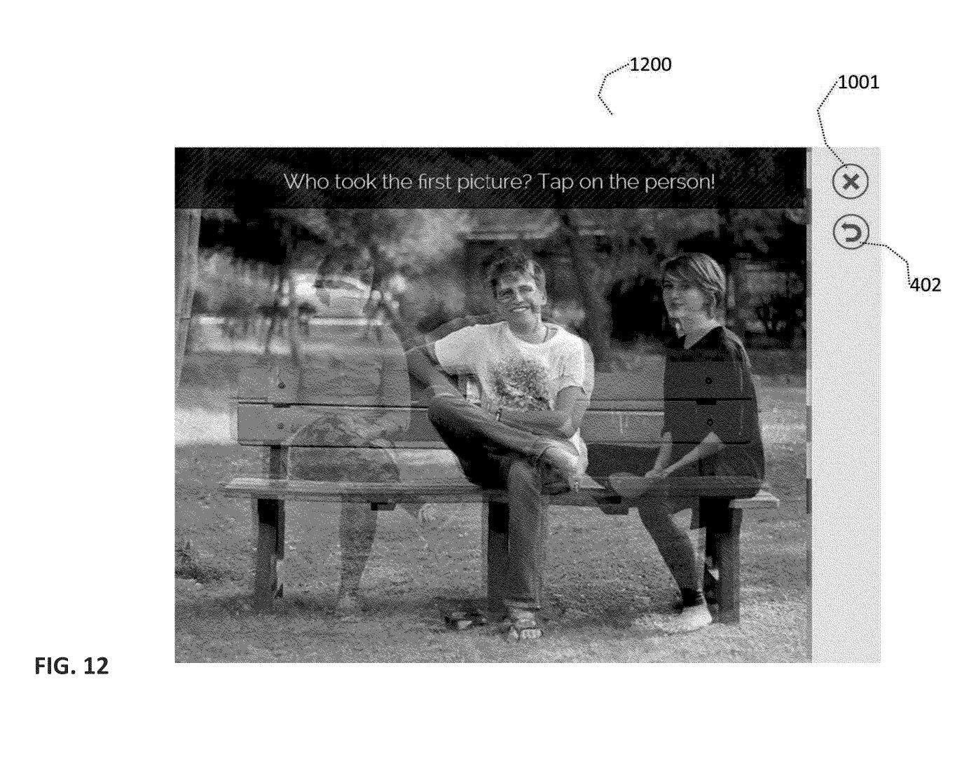

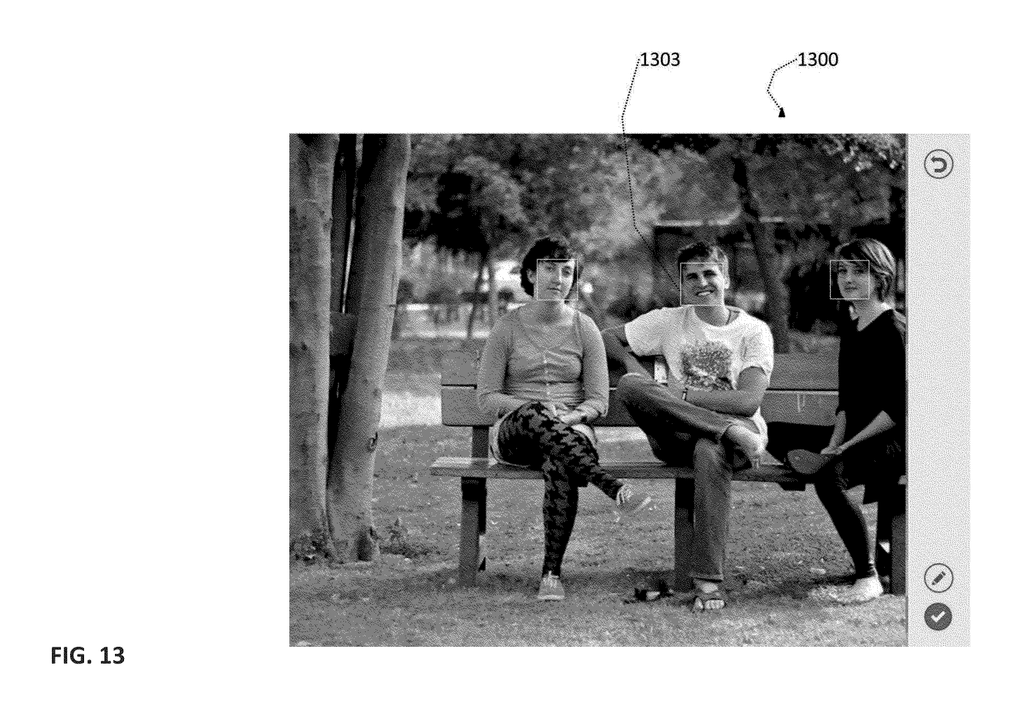

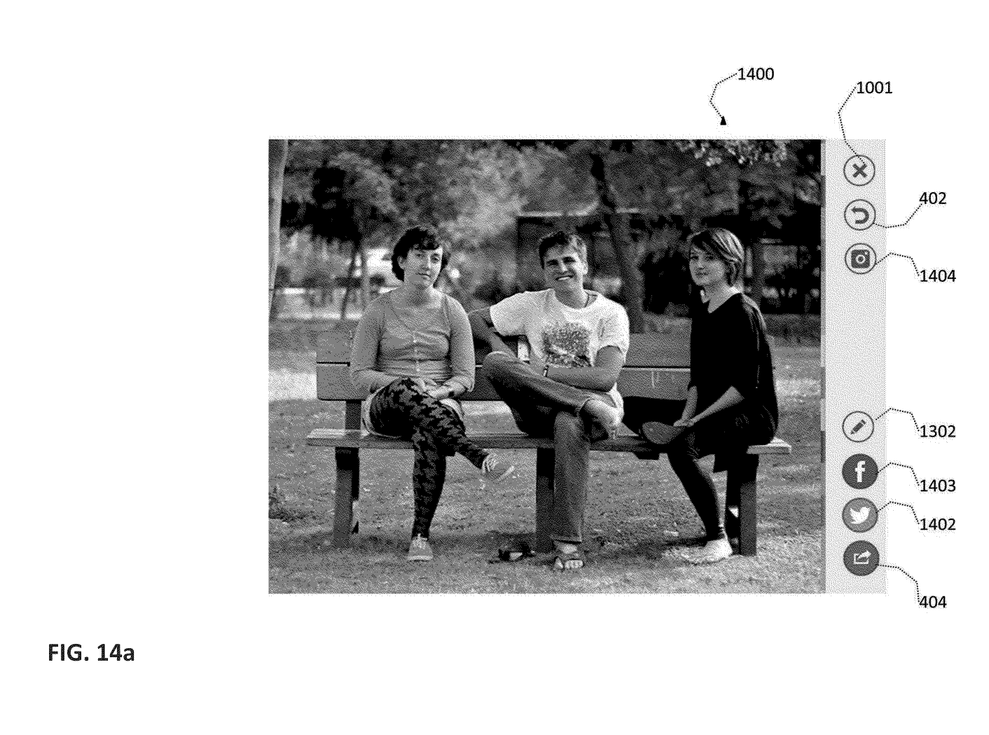

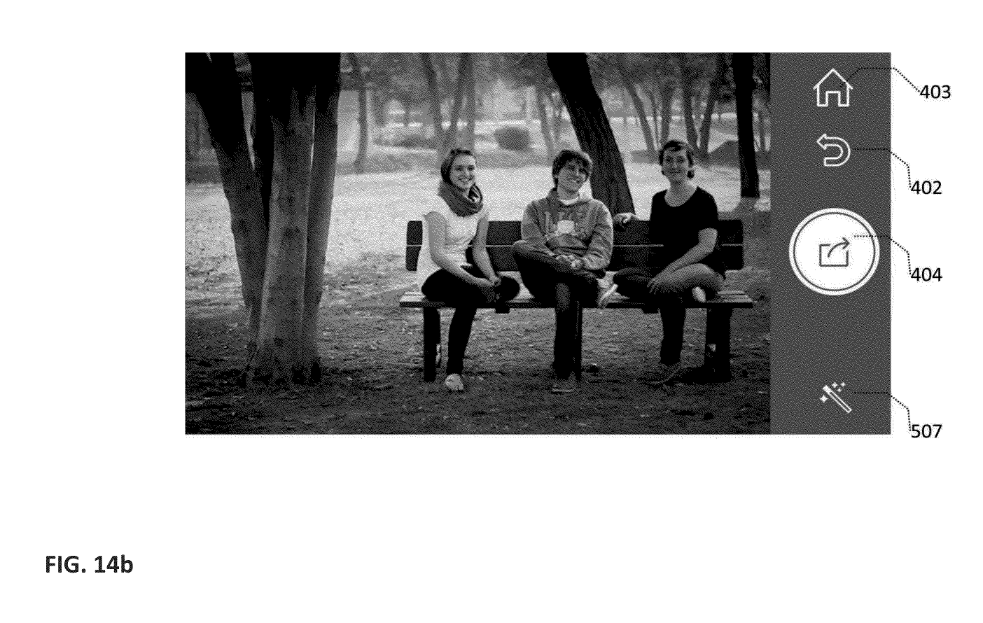

FIG. 12 shows an interface 1200 through which photographers can provide additional input to the system so that the final collaborative image can be created as per the needs of the user 101. In some aspects of the present invention, the user 101 is shown multiple images overlaid on one other for an input; alternatively, each photograph may be shown separately to the user 101 for input. FIG. 13 shows the interface 1300 presenting the final image 207 obtained by combining images taken by multiple photographers. It also shows that both the photographers are also part of the final image. The system automatically detects faces on the final image 207 and provides a tagging option to the user 101 through which a user can associate metadata with each detected face. The button 1301 allows the user 101 to complete the collaborative photography session. In some cases, the completion of the session automatically takes the user to the sharing interface 900. The button 1302 allows the user 101 to switch to editing an interface 600 for image editing. FIGS. 14a and 14b show an interface 1400 presenting final images obtained by combining images taken by multiple photographers. It also shows that both the photographers are also part of the final image. Furthermore, button 1302 allows the user to switch to the editing interface 600 for image editing. This interface also allows multiple options of sharing the generated digital content, such as buttons 1402 and 1403 which facilitate sharing on Twitter and Facebook respectively. Sharing on any other medium can be performed through button 1401. The user 101 can also decide not to share and start another collaborative photography session through button 1001.

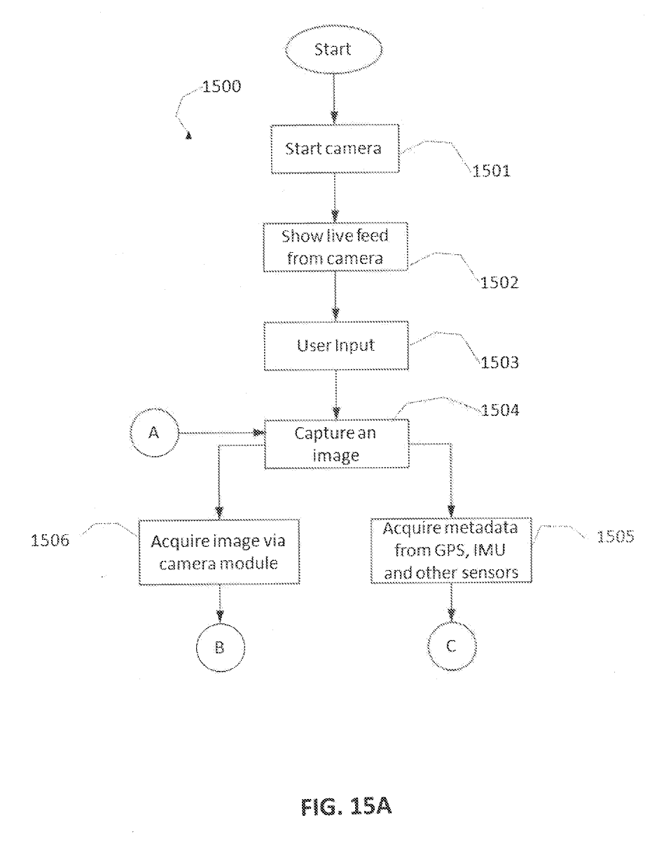

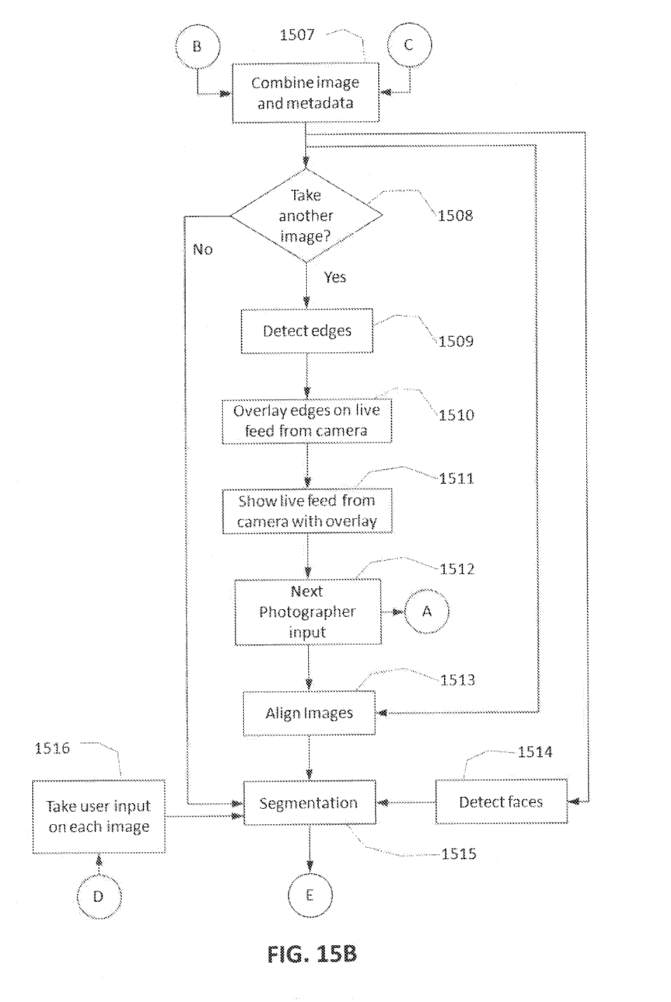

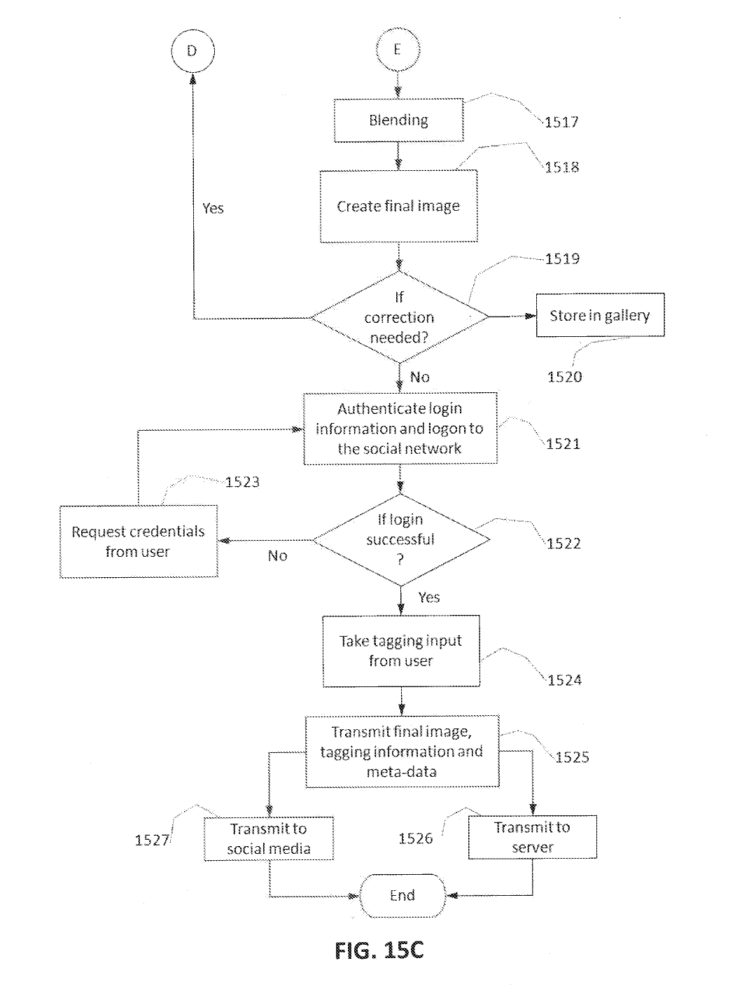

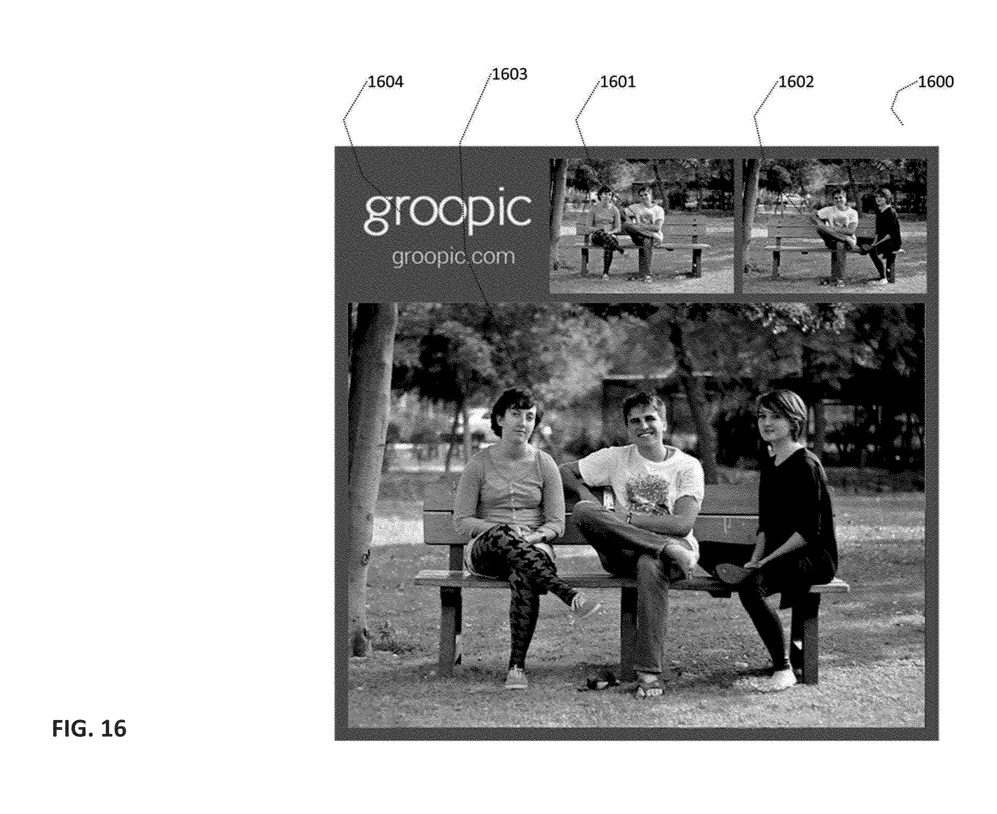

FIGS. 15a-15c show a flow diagram of a collaborative photography system 200. This flow is initiated when a user 101 of the system 200 performs a start camera operation 1501 by requesting an access to the camera module for image acquisition. The system checks the availability of the camera, initiates a data transfer with the camera, and starts showing a sequence of images acquired by the camera in the form of a live video feed 1502. The user 101 adjusts the camera view and when ready for image acquisition, provides an input 1503 to initiate an image capture operation 1504. The user input 1503 can be provided by pressing the button on the digital device 102. In some implementations, the image acquisition button can be a physical button present on the digital device; in some other implementations it can be a part of the interface and is shown on the display unit. When the user input is received, the camera modules may perform auto-focus functionality that adjusts the parameters of the imaging device. Alternatively, focusing may be performed using the input received from the input device 203. These parameters are acquired from the camera module and may be stored in the device memory. In some implementations, the camera module is instructed to lock these focusing parameters for all the further images that will be taken by multiple photographers during this collaborative photography session. In other words, the camera module is instructed to stop auto-focusing for the remaining image acquisition requests during this session.

Multiple parallel operations may be executed as a result of the image capture request 1504. These parallel operations may include a request to the camera module to acquire an image 1506 and a request to GPS, IMU, and other sensors to acquire additional data and store it in the available memory for further processing 1505. In some implementations, location information from a Global Positioning System (GPS) 204 present on the digital device 102 are stored in memory as additional metadata and for assisting in creating the final image 207. In some implementations, information from an Inertial Measurement Unit (IMU) 208 is also acquired and stored along with each image for providing assistance in further processing. In some implementations, additional metadata, including but not limited to audio, can also be stored with each image.

After the image, metadata and the camera parameters are combined 1507 and stored in memory. The system may then perform multiple parallel operations. These operations may include processing of the acquired image to facilitate the next photographer 1512, providing live camera feed for the next photographer 1510, and processing of the acquired image for creation of the final image 1518. The system may alternatively perform these operations in a sequential manner.

The system first decides, through user input or through preset counters, whether to take another image 1508. If the system decides to take another image, the system extracts certain information such as edges 1509 from the acquired image. The extracted information is first overlaid on the images received as live feed from camera 1510 to be shown to the next photographers along with the camera feed 1511. The purpose is to facilitate the next photographer in collaborating with the previous photographer by having some knowledge about the image acquired by the first photographer. In some embodiments, the system first performs a differentiation operation on the acquired image to obtain the high-frequency components of the image.

To detect the edges 1509, the system may perform a canny edge detector to extract the high-frequency components of the edges in the images. Prior to edge detection, multiple general linear and non-linear image processing operations are performed. The image is first converted into a grayscale image, and then a Gaussian blurring is applied on the image to reduce the high frequencies that are due to noise. This results in smoothing of the image. The resulting image is then processed for edge detection. The resulting output can also be defined as an outline of the objects present in the scene or the edges of the scene.

The camera module is again accessed to acquire the live image from the camera to be presented to the next photographer. However, this time the obtained images are not presented to the photographer in their raw form. Instead, the information extracted from the previously acquired image or images is also combined with the live view images 1510 and a modified image is presented to the user 1511. In some implementations, this information is combined by performing alpha blending, whereby two set of inputs are weighted and summed together to obtain a single combined image. Alternatively, the live view images and the image containing the information from the previous image (such as the edge image) are combined by simply adding the two images.

Additionally, the two images may be color coded to also indicate the similarity between the two images based on their overlap. In some implementations, the color coding may be performed to indicate alignment of the previous image with the current image from the live view. The edges of the current image are also computed, then the difference between the edges of the two images is computed. In some implementations, a difference between the previous image and current image from live view can also be computed. Arrows may also be shown that give directions to the users 101 to help better alignment between images. The color coding is performed by alpha blending another image with the combined image. As the difference in edges gets higher, the overlaid alpha-blended image gets redder; as the difference between the edges get lower, the overlaid alpha-blended image gets greener. In some implementations, the color of the color coding is determined using the difference between the previous image and current live view image instead of performing edge differences. This introduces a novel interactive real-time system for aligning two images while acquiring live feed from a camera. The image acquired at the previous step is also subjected to further processing in parallel or sequential manner to extract additional information needed for aligning images in the later step. This further processing includes extracting features that can be matched between a pair of images.

The next photographer then uses the system 200 to request the camera module for acquiring another image. Upon the request of each next photographer, the images are acquired 1504 and processed using the same procedure as for the first image. Similarly, for facilitating the next photographer, additional information is extracted from each acquired image. Additionally, information from GPS 204 and IMU 208 may also be acquired and stored for each image. As each image is acquired, the system checks the settings and decides whether to keep the acquired images in the memory only or to store each image in the gallery for later use by the users 101 of the system 200. After each image and associated information is acquired, the user 101 can decide whether to continue with the collaborative photography session or to stop taking any further images 1508 and proceed towards combining them. If the photographers decided to continue with the session, the live camera feed is again shown 1511 to the next photographer with the combined information about the previous image or images 1510. In some cases the same photographer can also be the next photographer.

While photographers continue taking more and more images, each acquired image is also passed to the alignment step 1513 along with stored metadata. In some implementations, the alignment block keeps processing these images in parallel with the image acquisition step. Alternatively, all the acquired images may be passed to the alignment phase only when the photographers decide not to take any further images.

Due to movement of people during the image acquisition, light sources may become obstructed and may also become unblocked, resulting in changes in scene illumination between two images. Such images, when combined together, can result in unpleasant and easily perceivable artifacts. In order to address this problem, in some implementations, the two images are passed through white color balancing, which is an important step in the digital image processing pipeline to adjust the color of the pixels under different illuminations. The algorithm used for white color balancing is based on the gray world assumption, which argues that for a typical scene, the average intensity of the red, green, and blue channels should be equal. First, the average of each channel of an image is computed, then a gain value for each of the red and blue channels is computed as a ratio between the average of the green channel with that of the red channel and the blue channel respectively. The image channels are then multiplied with their respective gains. The same process may be applied independently to each image, resulting in eliminating differences in the images due to differences in illumination.

At the alignment block, the system again checks the setting information and triggers several sub-processes as defined in the settings. The system utilizes the information in each image and IMU 208 information about each image to find the transformation that can align all the images. The system computes the rectification transformation by combining the information from the images 201 as well as information from the GPS 204 and IMU 208. The system performs a novel restrictive rectification transformation computation that excludes some degree of freedom from the performed non-linear optimization. This not only increases the speed of the algorithm necessary for a collaborative system; it also increases the stability of the algorithm, as the restrictive optimization also restricts the possibilities of incorrect solutions. This transformation is computed to warp each image on the first image acquired during the session. After warping, the system computes an overlap between the images. The system checks whether the corners of the warped image are within a predefined percentile (for example, 15%) of the original image corners, and establishes whether the same scene is imaged multiple times with different objects and/or photographers. In cases when the same scene is imaged multiple times, the system sets the dimensions of the final image to be the same as that of the original images. In cases when the corners of most of the warped images are beyond 15 percent of the original image corners, the system determines that a larger image is desired through a collaborative photography session. In such cases, this transformation is computed to warp each image on the previous image. In such cases, the n^{th} image is first warped on the n-1^{th} image and a combined image is obtained. This combined image is then warped on the n-2^{th} image and so on until the combined image is warped on the first image. The warped images are then sent to the next processing block for generating a combined image. If the optimization fails to obtain a valid alignment, the original images may be sent to the next processing block to create a final combined image 1518.

The image combination step may wait for the image acquisition process to finish and, in some implementations, may also request additional information about each image from the photographers/users 101 as described above. All of the information is then used to segment relevant regions from each of the images 1515. In some implementations, each image and the images warped on it are divided into cells, and each of these cells is treated as a graph. Using the smart face detection 1514 and/or available input from users 101, a region between two images is identified, at which point the images are divided into two images each, and then a portion from each image is chosen to create a combined image. This division is based on identifying which adjacent cells are least different. The region where the two images are joined is then further blended 1517 to remove any artifacts that are perceivable through human eyes, so that a final image can be created that appears like a single image. In some implementations, this further processing is through linear image processing operations. Alternatively, this additional processing to hide image difference can be non-linear image processing.

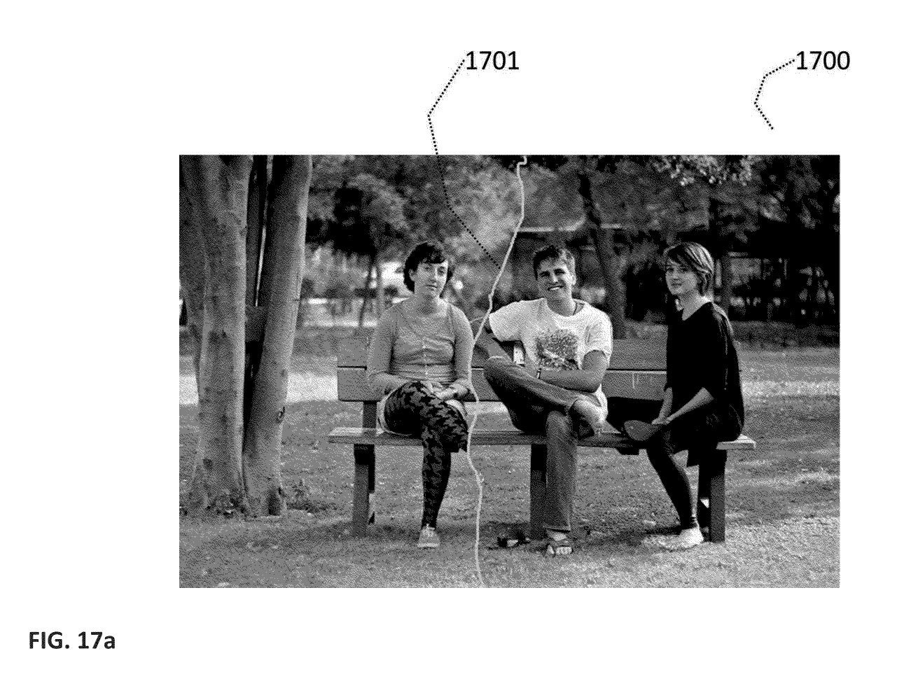

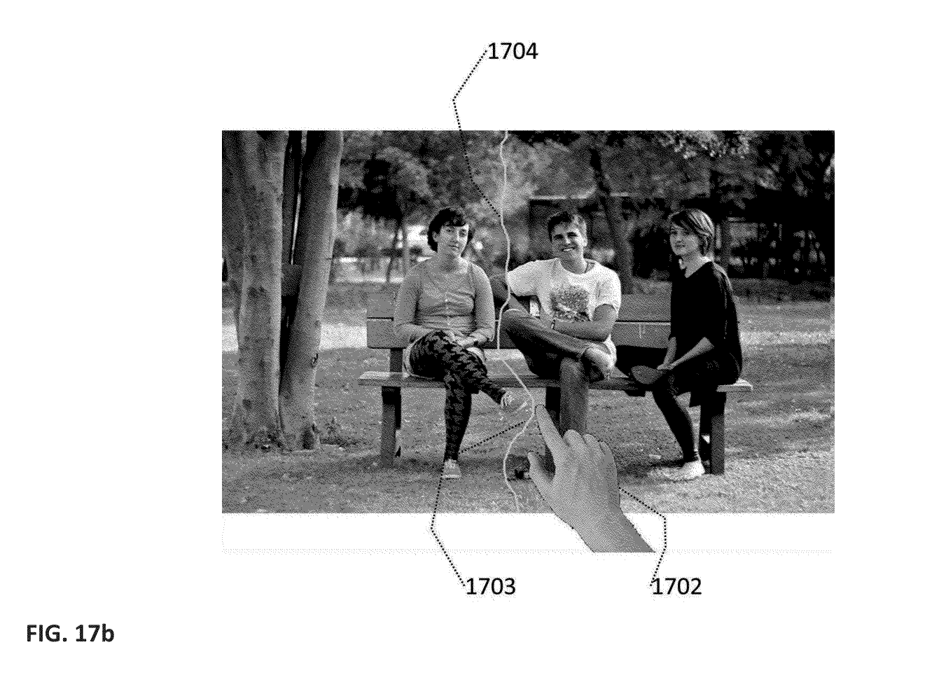

In some implementations, the user 101 is presented with an interface shown in FIGS. 17a and 17b to manually correct any remaining perceivable artifacts. As shown, a plurality of pixels are highlighted within the composite image, indicating the border at which a region from one image is joined to a region from another image. The user 101 can drag the border 1701 between the two regions by interacting with the highlighted plurality of pixels, such by tapping on a touch screen display 1702 or using a pointing device. When the user drags the pixel border 1703, the part of the region that is dragged over is replaced with the pixels from the image whose region is on the other side of the border. In some implementations, this replacement occurs by re-computing the extents of the two regions 1704 from the original aligned and rectified images by incorporating the user 101 input, resulting in an updated manually corrected composite image.

In some implementations, the edges of the two images are again utilized, and these edges are combined together into a single edge map. Projection histograms of these edges are then computed in the vertical direction, resulting in counting the number of edges along each column of the combined edge map. Within this projection histogram, a valley or a saddle point is identified, and that column is selected as the dividing line between two images, based on which region from each image is selected for generating combined images.

Some implementations of the present invention do not require user input to identify regions, and instead use automatic mechanisms (including but not limited to analyzing image features, smart face detection, and IMU data); this constitutes the “auto-group picture” aspect of the present invention.

In other implementations, this region selection is also aided with the user input. The user input may be taken at the time of acquiring each picture. In such cases, the user taps on one of the photographers in the current collaborative photography session and/or in the region which should be included in the final composite. This aspect of the present invention involving user 101 input while taking the pictures is referred to as “tap-with-snap.” In other cases, once all the pictures are taken, the user 101 of the collaborative photography session is presented with one or more of the pictures and is asked to mark either the photographers seen in the pictures or the region of interest in each of the images. This constitutes the “tap-after-snap” aspect of the present invention. The marking aspect of the present invention may only require tapping once on the screen of the digital device or by clicking once using a pointing device, and may not require or even allow the user to identify an entire region consisting of multiple points in the form of a boundary or a polygon. Such extended region identification is done automatically by the algorithm presented in this invention. In this case as well, after combing multiple images, further linear or non-linear image processing may be performed along the line where the two image regions are combined to hide visually unpleasant artifacts.

These segmented image regions are then stitched together and blended with each other 1517 to remove any perceivable artifacts. The stitching and blending step produces a composite final image 1518 that contains contribution from images acquired by multiple photographers, resulting in an image that is not possible to acquire naturally, instead an image that can only be possible through the use of the present invention. In some implementations, the user 101 can decide 1519 to correct any artifacts in the combined image by providing additional input 1516. Using the additional input and face locations from face detection 1514, the images are again segmented into regions, stitched, blended, and a final image is recreated. This final image is stored in the gallery 1520 for later use as well as for further processing. The system then processes the final image to automatically extract additional information about the image that can be added to the digital content of the image as metadata. In some implementations, this additional information could be location, and/or size and/or contour of automatically detected faces 1514 of people and photographers present in the image. In some implementations, this additional information could also be location, size, or contour of objects present in the scene. This additional information could also be about the concepts present in the scene. These concepts include but are not limited to lake, sea view, ocean, picnic, party, birthday, skiing, playing, animal, etc.

In some aspects of the present invention, the final image may be scrambled. The scrambling algorithm divides the image into an M×N grid, resulting in MN regions or patches, where M is the number of rows and N is the number of columns. Each of the patches is then moved to a uniquely identified new location in an equi-sized new image. The new location is computed based on a binary pattern obtained through a unique user-specific ID. In some implementations this ID could be a unique device ID. After an image has been divided into M×N patches, first the patches are rearranged in a sequential manner. The algorithm then reads the i^{th} bit (from the left) of the binary sequence: if that bit is 1, the i^{th} patch in the sequence retains its position; if the bit is 0, the i^{th} patch is swapped with the (MN−i)^{th} patch. In some implementations, the length of the binary sequence may be shorter than the number of patches; in such cases, the binary sequence is used as a circular array, such that after the last bit is used, the algorithm starts using the bits from the beginning

In some aspects of the present invention, the final image is a collage 1600 of multiple images taken during the collaborative photography session. In some aspects of the present invention, the collage shows both the final composite image and the intermediate images (such as 1601 and 1602) taken during the collaborative photography session. In some aspects, the collage is as shown in 1600 containing a first image 1601, a second image 1602 and a final composite image 1603. In some embodiments of the present invention, the collage may also contain a logo 1604, indicating a source of the application through which the collage has been created.

In some implementations, user gestures may be used as an additional interaction medium with the system. To identify such interaction gestures, the apparatus can have an additional camera on a digital device. When any body part of the user appears in front of the camera, it is identified and tracked in the acquired images. In some implementations, more than one body part may appear in front of the camera and multiple body parts are tracked to identify a gesture. In some implementations, even gestures could be composed of multiple tracks. For example, when the user looks into the camera, his or her face is identified and tracked as a possible gesture. In some implementations, a user's eyes, nose, and lips can be identified and tracked. In some implementations, multiple salient feature points on the face can be identified and tracked. In some implementations, a user's hand can be detected; a gesture could be based on a single track of the hand or a gesture could be based on tracking of the user's fingers. The track could be a track of spatial position, a track of orientations, a track of frequencies, a track of colors, a track of edges, a track of some other features, or a track of a combination of some or all of these. This obtained track or set of tracks is then compared with the tracks known to the system. Once this obtained track or set of tracks is classified as one of the known tracks, it is accepted as one of the known gestures, and the action associated with that gesture is executed. These actions include but are not limited to interaction with any of the controls on the interface screen such as identification of face 1303, interaction with camera button 302, gallery button 303, next digital content buttons 503 and 504, or a swipe action on the digital device 102.

The final image 207 and the associated metadata 206 may be stored in the gallery and also packaged into a network message to be transmitted over the internet 103. In some embodiments, the user 101 is then taken to the sharing interface 900. System settings and the previous session records are then checked by the system 200 to obtain user 101 credentials needed to connect and authenticate 1521 the user 101 on social media 104. In some embodiments, the user 101 is also given an option to connect to another or more social media sites than the one already used in previous sessions or specified in the setting. In case user credentials are not available or authentication fails 1522, in some embodiments the system asks the user 101 for credentials 1523. Once the credentials are authenticated successfully 1522 and a connection is established, the user may be asked to provide additional information, such as by tagging the people 1524 in the image or by adding metadata about the image. In some implementations, the user can be asked to just look at the potential locations where there is a face and the system identifies a face at that location based on user gesture. In some other cases, the system identifies the eye fixation point and uses it as a user gesture for wide variety of inputs, including but not limited to indication of a face location or a user interface (UI) component to be executed.

The system then transmits 1525 the created final image 207 and the metadata 206 over the Internet. In some implementations, two parallel transmissions are started, one to the social media 1527 and another to the system server 1526, from where it can be shared with the photographers who collaborated in the session and to other members of social media 104. In some implementations, the created final image 207 and the metadata 206 along with system usage data is sent to the system server 105. In some implementations, if the Internet 103 is not available, the information is stored in the gallery and later transmitted 1525 to the server 105 whenever the internet 103 becomes available.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

1. A computer-implemented method, comprising:
receiving a first image and a second image;
aligning the first image with the second image;
determining a first point of interest within the first image;
determining a second point of interest within the second image;
identifying a border for the aligned images; and
creating a composite image from the aligned first and second images and the border, wherein the composite image includes a first region of the first aligned image that includes the first point of interest and a second region of the second image that includes the second point of interest.

2. The method of claim 1, wherein the first point of interest corresponds to a location of a subject who is in the first image but not the second image, and the second point of interest corresponds to a location of a subject who is in the second image but not in the first image.

3. The method of claim 1, wherein identifying the border comprises determining a plurality of pixels wherein the differences between the pixels of the first aligned image and the corresponding pixels of the second aligned image are minimized.

4. The method of claim 1, further comprising:
color-balancing at least one of the images to match one or more color values of the other image.

5. The method of claim 1, wherein the first and second points of interest are identified automatically.

6. The method of claim 5, wherein at least one of the first and second points of interest are identified using at least one of a face-matching algorithm and a face-detection algorithm.

7. The method of claim 5, wherein at least one of the first and second points of interest are identified using a person-detection algorithm.

8. The method of claim 5, wherein at least one of the first and second points of interest are identified by calculating the differences between corresponding pixels of the first and second aligned images and identifying points of maximum difference.

9. The method of claim 1, wherein the first and second points of interest are identified by user input.

10. The method of claim 9, wherein each of the first and second points of interest are identified by the user with a single touch or click.

11. The method of claim 9, wherein a user selects a region comprising more than one point, and wherein at least one of the first and second points of interest are identified from the selected region.

12. The method of claim 1, further comprising:
displaying a first image feed, wherein the first image is recorded by user input during display of the first image feed;
following receiving the first image, displaying a second image feed, wherein the second image feed includes an image overlay based on the first image, and wherein the second image is recorded by user input during display of the second image feed including the image overlay.

13. The method of claim 12, wherein the image overlay is generated based on an edge calculation of the first image.

14. The method of claim 1, wherein aligning the first image with the second image comprises comparing an edge calculation of the first image with an edge calculation of the second image and positioning the images to minimize the differences between the calculated edges.

15. The method of claim 1, wherein the composite image is a first composite image, the method further comprising:
receiving a third image;
aligning the third image with the first composite image;
determining a third point of interest within the third image;
determining a fourth point of interest within the first composite image;
identifying a border for the aligned third image and first composite image; and
creating a second composite image from the aligned third image, aligned first composite image, and the border, wherein the second composite image includes a third region of the third aligned image that includes the third point of interest and a fourth region of the first composite image that includes the fourth point of interest.

16. The method of claim 15, wherein the fourth region includes the first point of interest and the second point of interest.

17. The method of claim 1, further comprising:
receiving a background image;
wherein the composite image further includes a background region from the background image.

18. The method of claim 1, wherein creating the composite image comprises:
applying linear and non-linear signal processing to the first and second images;
computing warping of the first and second images; and
computing a division designating the first and second regions using edge calculations and projection histograms.

19. A system for collaborative photography, comprising:
a camera;
a display; and
at least one processor operable to:
display a first live feed on the display;
in response to user input while the first live feed is displayed, record a first image with the camera;
display a second live feed on the display, the second live feed including an overlay based on the first image;
in response to user input while the second live feed is displayed, record a second image with the camera;
receive as user input a single touch or click representing a first point of interest associated with the first image;
receive as user input a single touch or click representing a second point of interest associated with the second image;
align the first image with the second image;
create a composite image including a first region of the first aligned image that includes the first point of interest and a second region of the second aligned image that includes the second point of interest; and
displaying the composite image on the display.
